(19) United States
(12) Patent Application Publication
(10) Pub. No.: US 2015/0213555 A1
(43) Pub. Date: Jul. 30, 2015

(54) PREDICTING DRIVER BEHAVIOR BASED ON USER DATA AND VEHICLE DATA

(71) Applicant: HTI IP, LLC, Atlanta, GA (US)

(72) Inventors: James Ronald BARFIELD, JR., Atlanta, GA (US); Stephen Christopher WELCH, Atlanta, GA (US)

(73) Assignee: HTI IP, LLC, Atlanta, GA (US)

(21) Appl. No.: 14/164,862

(22) Filed: Jan. 27, 2014

(51) Int. Cl. G06Q 40/08; H04W 4/04

(52) U.S. Cl. CPC G06Q 40/08; H04W 4/046

(57) ABSTRACT

A system may determine driving information associated with a group of users, the driving information may be based on sensor information collected by at least two of a group of user devices, a first group of vehicle devices connected to a corresponding group of vehicles associated with the group of users, or a group of second vehicle devices installed in the corresponding group of vehicles. The system may determine non-driving information associated with the group of users. The system may create a driver behavior prediction model based on the driving information and the non-driving information, and may store the driver behavior prediction model. The driver behavior prediction model may permit a driver prediction to be made regarding a particular user (e.g., a user that is not necessarily included in the group of users). The driver behavior prediction may be associated with a particular geographic location.

### BACKGROUND

Usage-based insurance is a type of insurance where a cost of insurance is dependent upon one or more factors specific to a subject of the insurance. For example, usage based automotive insurance is a type of automotive insurance where the cost to insure a vehicle may depend on a variety of factors, such as measured driving behavior of a driver of the vehicle, a driver history of the driver, a location (e.g., a city, a state, etc.) where the insured vehicle is typically driven, or other information.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3A is a diagram of example components of one or more devices of FIG. 2;

FIG. 3B is another diagram of example components of one or more devices of FIG. 2;

FIG. 4 is a flow chart of an example process for determining driver distraction information associated with a driver of a vehicle;

FIG. 5 is a flow chart of an example process for determining suspicious behavior information associated with a driver of a vehicle;

FIG. 6 is a flow chart of an example process for determining accident information associated with a vehicle;

FIG. 7 is a flow chart of an example process for determining distance information associated with an average acceleration event, associated with a plurality of drivers, and a particular acceleration event associated with a particular driver;

FIGS. 8A and 8B are diagrams of an example implementation relating to the example process shown in FIG. 7;

FIG. 9 is a flow chart of an example process for generating a driver prediction model based on driving information and non-driving information associated with a group of drivers;

FIG. 10 is a diagram of an example implementation relating to the example process shown in FIG. 9;

FIG. 11 is a flow chart of an example process for generating a driver prediction based on a driver behavior prediction model and information associated with a driver; and

FIG. 12 is a diagram of an example implementation relating to the example process shown in FIG. 11.

### DETAILED DESCRIPTION

The following detailed description of example implementations refers to the accompanying drawings. The same reference numbers in different drawings may identify the same or similar elements.

An insurance provider may wish to predict driver behavior associated with a driver of a vehicle (e.g., for purposes of determining an insurance cost for the driver). Applying a usage-based insurance (UBI) technique to create a driver behavior prediction model is one way to achieve this goal. The driver behavior prediction model may be based on information received from a variety of sources of information associated with the driver and/or the vehicle. For example, one or more sensors may be designed to determine driving information associated with the driver and/or the vehicle, such as a sensor included in a vehicle device (e.g., a device attached to a vehicle driven by the driver), a sensor included in a user device (e.g., a smart phone associated with the driver), and/or one or more other sensors designed to record, process, and/or store driving information. As another example, the driver behavior prediction model may be created based on non-driving information associated with the driver (e.g., driver demographic information, historical driver information, geographic information, weather information, traffic information, elevation information, etc.).

Implementations described herein may allow a driver behavior prediction model to be created based on information (e.g., driving information, non-driving information, etc.), gathered from a variety of sources (e.g., sensors, devices, databases, etc.), associated with a driver and/or a vehicle. In this way, the driver behavior prediction model may be used to predict a future driving behavior associated with the driver.

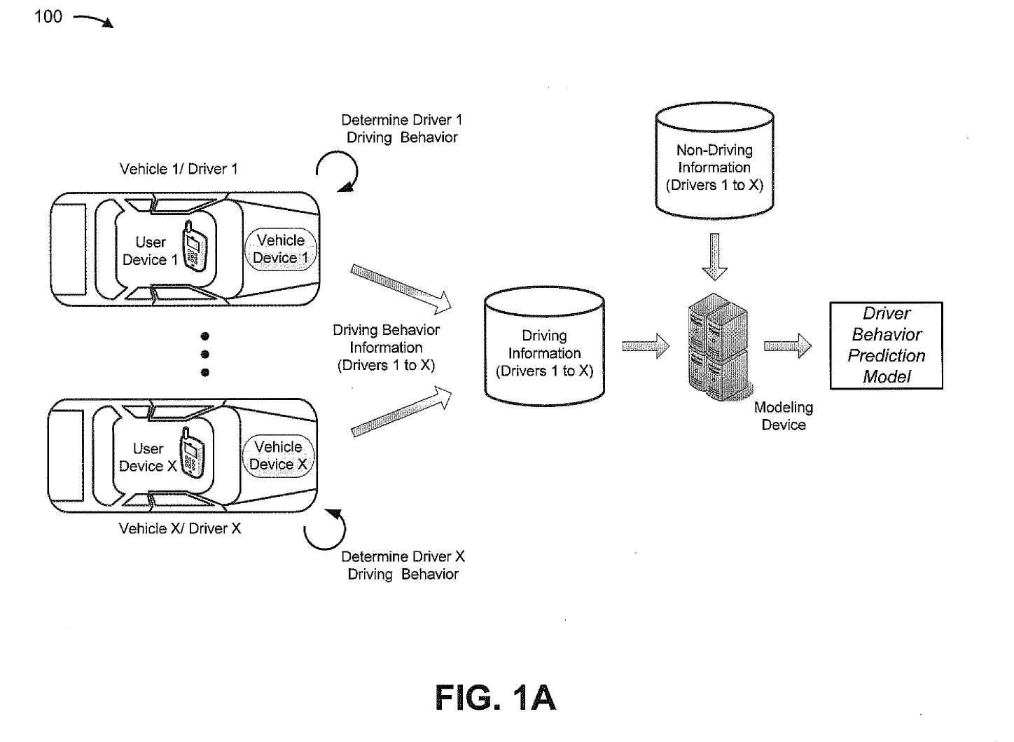

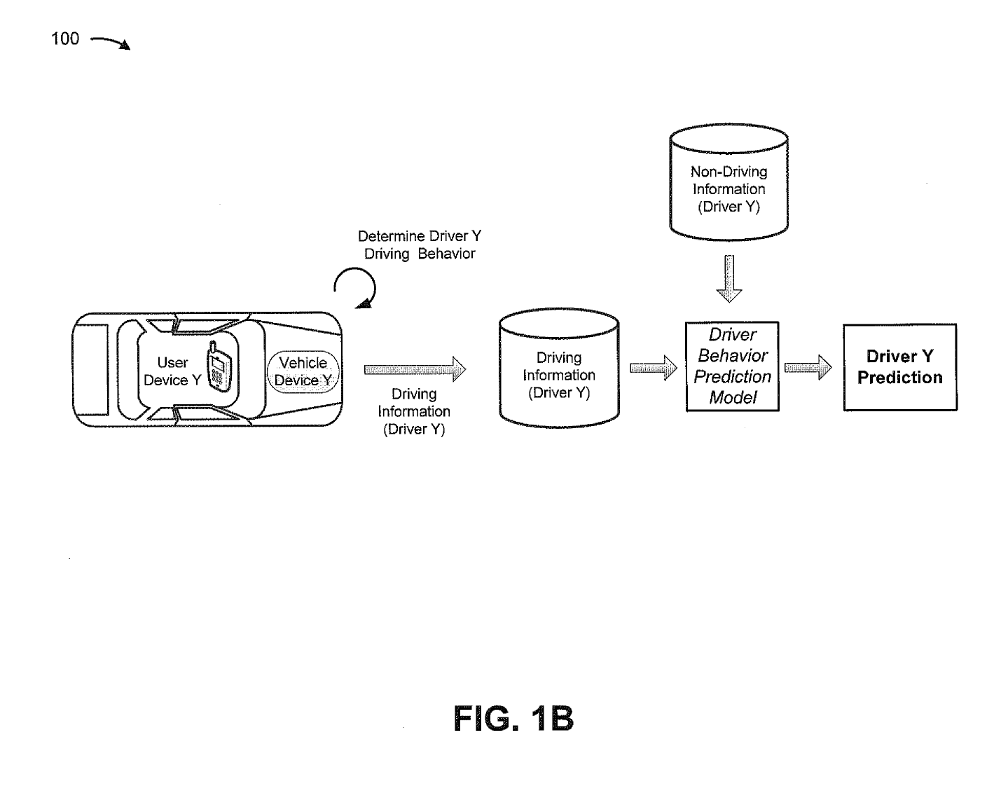

FIGS. 1A and 1B are diagrams of an overview of an example implementation 100 described herein. For the purposes of example implementation 100, assume that a number of vehicles (e.g., vehicle 1 through vehicle X), each associated with a driver (e.g., driver 1 through driver X) and a user device (e.g., user device 1 through user device X), include vehicle devices (e.g., vehicle device 1 through vehicle device X). Further, assume that each user device and vehicle device include sensors configured to determine driving information (e.g., information indicative of driving behavior of a driver) associated with each respective driver. Finally, assume that non-driving information, associated with each driver (e.g., driver demographic information, historical driver information, geographic information, weather information, traffic information, elevation information, etc.), is stored by a non-driving information device.

As shown in FIG. 1A, driver 1 may drive vehicle 1, and user device 1 and vehicle device 1 may determine (e.g., based on sensor data) driving information (e.g., driver distraction information, suspicious behavior information, accident data, acceleration event information, speed information, location information, etc.) indicative of a variety of driving behaviors (e.g., driver safety, driver aggression, etc.) of driver 1. As shown, user device 1 and/or vehicle device 1 may determine the driving information, and may provide the driving information to a driving information storage device. As shown, driving information associated with driver X may be determined and sent to the driving information storage device in a similar manner. In this way, driving information, associated with a large group of drivers, may be gathered and stored by the driving information storage device.

As further shown in FIG. 1A, a modeling device may determine (e.g., based on the stored driving information determined by the various user devices and vehicle devices) the driving information associated with driver 1 through driver X, and may determine (e.g., based on information stored by the non-driving information device) non-driving information associated with driver 1 through driver X. As shown, the modeling device may generate (e.g., based on parameters provided by a user of the modeling device) a driver behavior prediction model based on the various types of information, and the modeling device may store the driver behavior prediction model.

As shown in FIG. 1B, driver Y may drive vehicle Y, and user device Y and vehicle device Y may determine (e.g., based on sensor data) driving information indicative of a variety of driving behaviors of driver Y. As further shown, user device Y and/or vehicle device Y may determine the driving information, and may provide the driving information to a driver information storage device.

For the purposes of example implementation 100, assume that the user of the modeling device wishes to generate a driver prediction for driver Y. As shown, the driving information, associated with driver Y may be provided to the driver behavior prediction model (e.g., stored by the modeling device) along with non-driving information associated with driver Y. As shown, the various types of information may be provided to the driver behavior prediction model, and the driver behavior prediction model may generate a driver Y driving prediction. The driver Y driving prediction may then be used (e.g., by the user) to predict a future driving behavior of driver Y. For example, the driver Y prediction may be used by an insurance provider for the purpose of determining an insurance cost for driver Y.

In this way, a driver behavior prediction model may be created based on information (e.g., driving information, non-driving information, etc.), gathered from a variety of sources (e.g., sensors, devices, databases, etc.), associated with a group of drivers, and the driver behavior prediction model may be used to predict a future driving behavior associated with a particular driver.

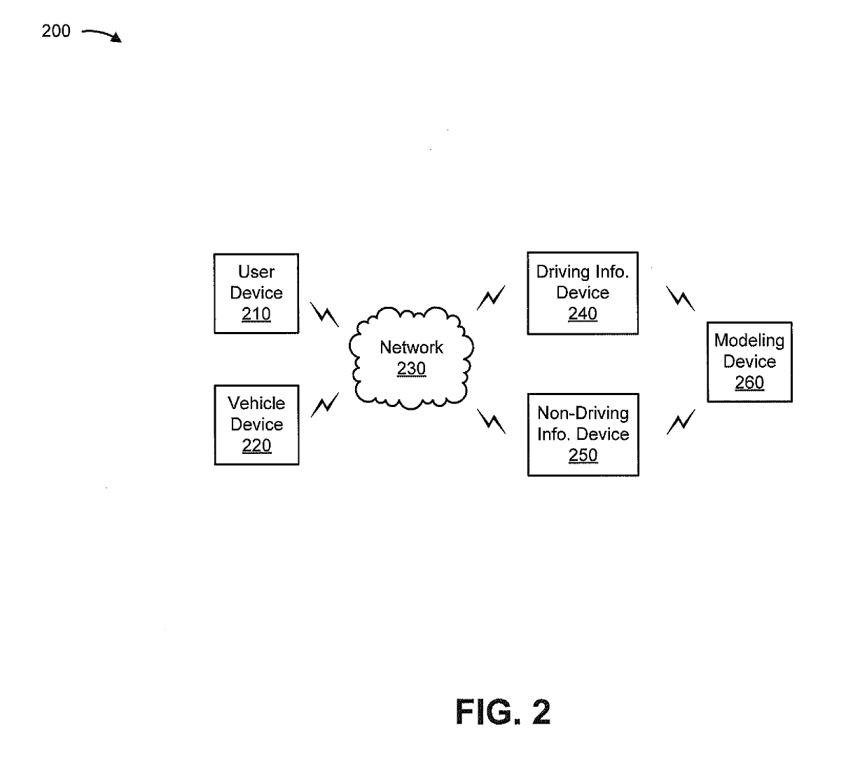

FIG. 2 is a diagram of an example environment 200 in which systems and/or methods described herein may be implemented. As shown in FIG. 2, environment 200 may include a user device 210, a vehicle device 220, a network 230, a driving information device 240, a non-driving information device 250, and a modeling device 260.

User device 210 may include a device capable of receiving sensor information, and determining, processing, storing, and/or providing driving information associated with a driver of a vehicle based on the sensor information received by user device 210. For example, user device 210 may include a wireless communication device, a personal digital assistant (“PDA”) (e.g., that can include a radiotelephone, a pager, Internet/intranet access, etc.), a smart phone, a tablet computer, a wearable computing device, a wearable biomarker device, or another type of device.

In some implementations, user device 210 may include a group of sensors associated with determining driving information, such as an accelerometer, a gyroscope, a magnetometer, a location sensor (e.g., a global positioning system (GPS) sensor), a magnetometer, a proximity sensor, a camera, an audio sensor (e.g., a microphone), a thumbprint sensor, or another type of sensor, as discussed below. Additionally, or alternatively, user device 210 may be capable of hosting an application associated with receiving sensor information, and processing the sensor information to determine driving information based on the sensor information. In some implementations, user device 210 may be capable of communicating with vehicle device 220, driving information device 240 and/or another device via network 230 using a wired connection (e.g., a universal serial bus (USB) connection, etc.) and/or a wireless connection (e.g., a Bluetooth connection, a WiFi connection, a near-field communication (NFC) connection, etc.).

Vehicle device 220 may include a device capable of receiving sensor information, and determining, processing, storing, and/or providing driving information associated with a driver of a vehicle based on the sensor information received by vehicle device 220. For example, vehicle device 220 may include a sensor and/or a telematics device installed within and/or on a vehicle. In some implementations, vehicle device 220 may include a group of sensors associated with determining driving information, such as an accelerometer, a gyroscope, a location sensor (e.g., a GPS sensor), a magnetometer, a proximity sensor, barometric pressure sensor, a camera, an audio sensor (e.g., a microphone), a thumbprint sensor, or another type of sensor, as discussed below. In some implementations, vehicle device 220 may be installed during manufacture of the vehicle. Alternatively, vehicle device 220 may be installed post-manufacture as an aftermarket device. In some implementations, vehicle device 220 may be connected with, coupled to, and/or used in association with a communication bus of the vehicle, such as a telematics dongle that interfaces with a communication bus through an onboard diagnostic (OBD, OBD-II, etc.) port of the vehicle. In some implementations, vehicle device 220 may be capable of communicating with user device 210, driving information device 240 and/or another device via network 230 using a wired connection (e.g., a USB connection, etc.) and/or a wireless connection (e.g., a Bluetooth connection, a WiFi connection, an NFC connection, etc.).

Network 230 may include one or more wired and/or wireless networks. For example, network 230 may include a cellular network, a public land mobile network (“PLMN”), a local area network (“LAN”), a wide area network (“WAN”), a metropolitan area network (“MAN”), IEEE 802.11 network (“Wi-Fi”), a telephone network (e.g., the Public Switched Telephone Network (“PSTN”)), an ad hoc network, an intranet, the Internet, a fiber optic-based network, and/or a combination of these or other types of networks. In some implementations, network 230 may allow communication between devices, such as user device 210, vehicle device 220, driving information device 240, non-driving information device 250, and/or modeling device 260.

Driving information device 240 may include a device capable of receiving, processing, storing, and/or providing driving information associated with a driver of a vehicle. For example, driving information device 240 may include a server device. In some implementations, driving information device 240 may be capable of receiving driving information from user device 210 and/or vehicle device 220. Additionally, or alternatively, driving information device 240 may be capable of storing the driving information (e.g., in a data structure). Additionally, or alternatively, driving information device 240 may be capable of providing the driving information to another device, such as modeling device 260.

Non-driving information device 250 may include a device capable of receiving, processing, storing, and/or providing non-driving information associated with a driver of a vehicle. For example, non-driving information device 250 may include a server device. In some implementations, non-driving information device 250 may be capable of receiving non-driving information, associated with a driver, and storing the non-driving information (e.g., in a data structure). Additionally, or alternatively, non-driving information device 250 may be capable of providing the non-driving information to another device, such as modeling device 260.

Modeling device 260 may include a device capable of creating a driver behavior prediction model, and generating a driver behavior prediction based on the model. For example, modeling device 260 may include a server device. In some implementations, modeling device 260 may be capable of receiving driving information (e.g., from driving information device 240) and non-driving information (e.g., from non-driving information device 250), and creating the driver behavior prediction model based on the information. Additionally, or alternatively, modeling device 260 may be capable of generating a driver behavior prediction based on the model. Additionally, or alternatively, modeling device 260 may be capable of training and/or updating the driver behavior prediction model (e.g., based on additional driving information, based on input from a user associated with modeling device 260, etc.).

The number of devices and networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more of the devices shown in FIG. 2 may be implemented within a single device, or a single device shown in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

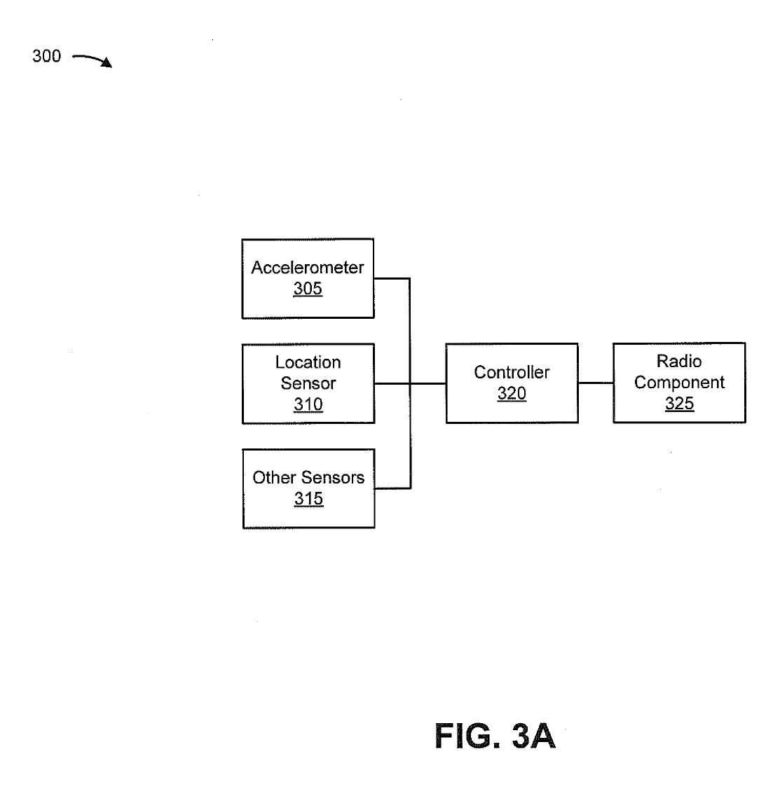

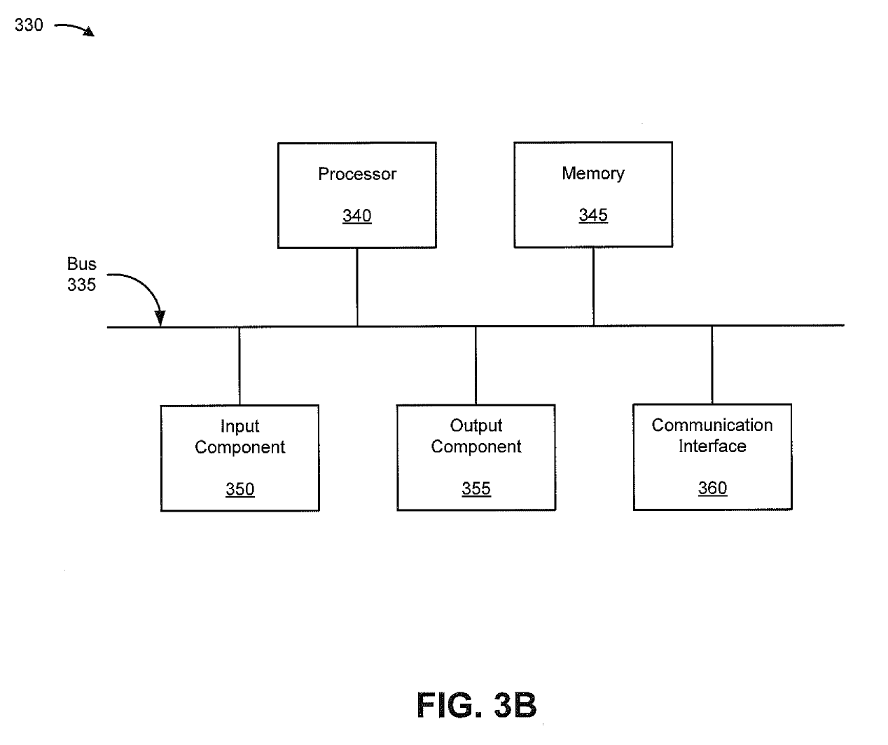

FIG. 3A is a diagram of example components of a device 300. Device 300 may correspond to user device 210 and/or vehicle device 220. Additionally, or alternatively, each of user device 210 and/or vehicle device 220 may include one or more devices 300 and/or one or more components of device 300. Additionally, user device 210 and/or vehicle device 220 may include one or more other devices, such as device 330, as discussed below. As shown in FIG. 3A, device 300 may include an accelerometer 305, a location sensor 310, other sensors 315, a controller 320, and a radio component 325.

Accelerometer 305 may include an accelerometer that is capable of measuring an acceleration, associated with a vehicle, and outputting information associated with the measured acceleration. For example, accelerometer 305 may measure the acceleration, and may output the acceleration as three acceleration values, each corresponding to an acceleration value associated with one of three orthogonal axes (e.g., an X-axis, a Y-axis, a Z-axis). In some implementations, the acceleration values, measured by accelerometer 305, may be provided to controller 320 for processing.

Location sensor 310 may include a sensor designed to determine the geographic location (e.g., a latitude, a longitude, etc.) of a device (e.g., user device 210, vehicle device 220). For example, location sensor 310 may include a GPS sensor, a GLONASS-based sensor, or another type of sensor used to determine a location. In some implementations, the location information, determined by location sensor 310, may be provided to controller 320 for processing.

Other sensors 315 may include other environmental sensors capable of measuring information associated with determining driving information. For example, other sensors 315 may include a barometric pressure sensor, a gyroscope, a magnetometer, a proximity sensor, a temperature sensor, a light sensor (e.g., a photodiode sensor), an altimeter sensor, an infrared sensor, an audio sensor, or a biomarker sensor (e.g., a fingerprint sensor), or another type of sensor (e.g. a spectrometer, a heart rate sensor, a variable heart rate sensor, a blood oxygen sensor, a glucose sensor, a blood alcohol sensor, a temperature sensor, a humidity sensor, etc.). In some implementations, the sensor information, determined by other sensors 315, may be provided to controller 320 for processing.

Controller 320 may include a microcontroller, a processor, or another processing device and/or circuit used to control user device 210 and/or vehicle device 210. In some implementations, controller 320 may include and/or be capable of communicating with a memory component that may store instructions for execution by controller 320. Additionally, or alternatively, controller 320 may determine, detect, store, and/or transmit driving information associated with a driver (e.g., based on sensor information received by controller 320).

Radio component 325 may include a component to manage a radio interface, such as a radio interface to wirelessly connect to network 230. For example, radio component 325 may provide an interface to a wireless cellular network (e.g., a ZigBee network, a Bluetooth network, a Wi-Fi network, etc.) associated with network 230. In some implementations, radio component 325 may include one or more antennae and corresponding transceiver circuitry.

The number of components shown in FIG. 3A is provided for explanatory purposes. In practice, device 300 may include additional components, fewer components, different components, or differently arranged components than those shown in FIG. 3A.

FIG. 3B is a diagram of example components of a device 330. Device 330 may correspond to user device 210, vehicle device 220, driving information device 240, non-driving information device 250, and/or modeling device 260. Additionally, or alternatively, each of user device 210, vehicle device 220, driving information device 240, non-driving information device 250, and/or modeling device 260 may include one or more devices 330 and/or one or more components of device 330. As shown in FIG. 3B, device 330 may include a bus 335, a processor 340, a memory 345, an input component 350, an output component 355, and a communication interface 360.

Bus 335 may include a path that permits communication among the components of device 330. Processor 340 may include a processor, a microprocessor, and/or any processing component (e.g., a field-programmable gate array (“FPGA”), an application-specific integrated circuit (“ASIC”), etc.) that interprets and/or executes instructions. In some implementations, processor 340 may include one or more processor cores. Memory 345 may include a random access memory (“RAM”), a read only memory (“ROM”), and/or any type of dynamic or static storage device (e.g., a flash memory, a magnetic memory, an optical memory, etc.) that stores information and/or instructions for use by processor 340.

Input component 350 may include any component that permits a user to input information to device 330 (e.g., a keyboard, a keypad, a mouse, a button, a switch, etc.). Output component 355 may include any component that outputs information from device 330 (e.g., a display, a speaker, one or more light-emitting diodes (“LEDs”), etc.).

Communication interface 360 may include any transceiver-like component, such as a transceiver and/or a separate receiver and transmitter, that enables device 330 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 330 may perform various operations described herein. Device 330 may perform these operations in response to processor 340 executing software instructions included in a computer-readable medium, such as memory 345. A computer-readable medium is defined as a non-transitory memory device. A memory device includes memory space within a single physical storage device or memory space spread across multiple physical storage devices.

Software instructions may be read into memory 345 from another computer-readable medium or from another device via communication interface 360. When executed, software instructions stored in memory 345 may cause processor 340 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3B is provided for explanatory purposes. In practice, device 330 may include additional components, fewer components, different components, or differently arranged components than those shown in FIG. 3B.

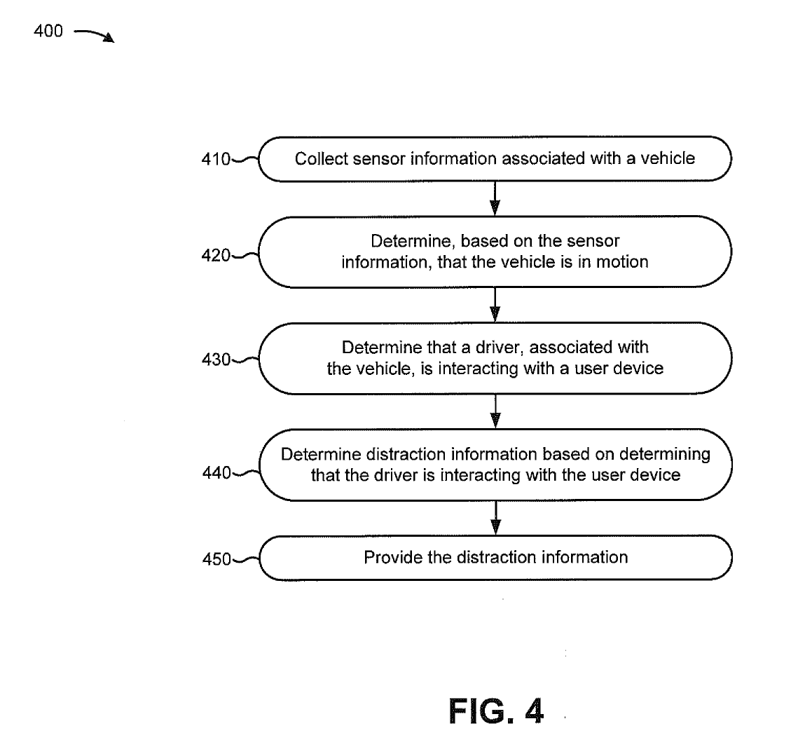

FIG. 4 is a flow chart of an example process 400 for determining distraction information associated with a driver of a vehicle. In some implementations, process 400 may be implemented using both user device 210 and/or vehicle device 220. For example, user device 210 and vehicle device 220 may concurrently (e.g., simultaneously) collect sensor information pertaining to a driver, and user device 210 may determine driver distraction information based on sensor information collected by user device 210 and sensor information collected by vehicle device 220 (e.g., when the sensor information collected by vehicle device 220 is provided to user device 210). The blocks of process 400 are primarily discussed herein as being performed by user device 210. However, in some implementations, process 400 may be performed by user device 210 and/or vehicle device 220.

As shown in FIG. 4, process 400 may include collecting sensor information associated with a vehicle (block 410). For example, user device 210 may collect sensor information associated with a vehicle. As an additional example, vehicle device 220 may collect sensor information associated with the vehicle. In some implementations, user device 210 and/or vehicle device 220 may collect the sensor information via on one or more sensors included in user device 210 and/or vehicle device 220.

In some implementations, sensor information may include information collected by a sensor that may be used to determine driving distraction information associated with a driver of a vehicle. For example, sensor information may include acceleration information, location information, barometric pressure information, gyroscope information, magnetometer information, proximity information, temperature information, light sensor information, altitude information, audio information, biomarker information, or another type of sensor information. In some implementations, one or more components of user device 210 and/or vehicle device 220 may collect and process the sensor information. In some implementations, vehicle device 220 may collect the sensor information, and may provide the sensor information to user device 210 (e.g., when user device 210 is configured to determine distraction information based on sensor information collected by user device 210 and/or vehicle device 220).

As further shown in FIG. 4, process 400 may include determining, based on the sensor information, that the vehicle is in motion (block 420). For example, user device 210 may determine that the vehicle is in motion. In some implementations, user device 210 may determine that the vehicle is in motion when user device 210 and/or vehicle device 220 collect the sensor information (e.g., after user device 210 and/or vehicle device 220 collect the sensor information).

In some implementations, user device 210 may determine that the vehicle is in motion based on sensor information associated with one or more sensors included in user device 210, such as a GPS sensor, an accelerometer, a gyroscope, a magnetometer, a wireless network signal strength (e.g., a WiFi network, a Bluetooth network, etc.), a cellular tower signal strength (e.g., to use in triangulation). Additionally, or alternatively, user device 210 may determine that the vehicle is in motion based on sensor information associated with one or more sensors included in vehicle device 220, such as a speed sensor monitored through an OBD port. For example, vehicle device 220 may sample GPS location data at a frequency (e.g., 1 Hertz (Hz), 2 Hz, etc.), and if the difference between consecutive GPS coordinates satisfies a threshold for a default number of samples, then vehicle device 220 may determine that the vehicle is in motion. In this example, vehicle device 220 may then provide information indicating that the vehicle is in motion to user device 210.

As further shown in FIG. 4, process 400 may include determining that a driver, associated with the vehicle, is interacting with a user device (block 430). For example, user device 210 may determine that a driver, associated with the vehicle, is interacting with user device 210. In some implementations, user device 210 may determine that the driver is interacting with user device 210 after user device 210 determines that the vehicle is in motion.

In some implementations, user device 210 may determine that the driver is interacting with user device 210 based on sensor information associated with user device 210. For example, sensor information (e.g., collected by user device 210) may indicate that the driver is interacting with a display screen of user device 210 and/or that the driver is using an application hosted by user device 210. The sensor information may also indicate other user device 210 interactions, such as text messaging, unlocking a lock screen, placing a voice call, or another activity indicative of the driver interacting with user device 210.

As further shown in FIG. 4, process 400 may include determining distraction information based on determining that the driver is interacting with the user device (block 440). For example, user device 210 may determine distraction information based on determining that the driver is interacting with user device 210 while the vehicle is in motion. In some implementations, user device 210 may determine the distraction information when user device 210 determines that the driver is interacting with user device 210 (e.g., after user device 210 determines that the driver is interacting with user device 210 when the vehicle is in motion).

In some implementations, distraction information may include a type of driving information associated with a driver interacting with user device 210 while the vehicle is in motion. For example, user device 210 and/or vehicle device 220 may determine that the vehicle is in motion, and user device 210 may determine that the driver interacted with user device 210 to cause a text message to be sent while the vehicle was in motion. In this example, the distraction information may include information associated with the driver interaction with user device 210, such as a type of the interaction (e.g., typing text message, unlocking a lock screen, using a web browser, etc.), a location of the vehicle at the time of the interaction, a time that the interaction occurred, a duration of the interaction, a speed of the vehicle at the time of the interaction, and/or other interaction information.

In some implementations, user device 210 may determine that the user interacting with user device 210 is the driver of the vehicle (e.g., rather than a passenger). For example, user device 210 may determine a distance of user device 210 within the vehicle relative to a sensor included in the vehicle (e.g., a sensor included in a steering wheel of the vehicle, a sensor positioned near the driver of a vehicle, etc.), and user device 210 may determine that that user interacting with user device 210 is the driver based on the distance. In this example, user device 210 may determine that that user interacting with user device 210 is the driver when the distance is a small distance (e.g., less than one foot, less than two feet, etc.), and user device 210 may determine that that user interacting with user device 210 is not the driver when the distance is a large distance (e.g., greater than five feet, greater than six feet, etc.) Additionally, or alternatively, user device 210 may determine that the driver interacting with user device 210 is associated with user device 210 (e.g., rather than a driver using user device 210 borrowed from an owner and/or primary user of user device 210). For example, user device 210 may determine that the driver interacting with user 210 is the owner and/or primary user of user device 210 based on a sensor included in user device 210, such as a biometric sensor (e.g., a fingerprint sensor, an optical sensor, etc.).

In some implementations, user device 210 may determine the distraction information, and user device 210 may enter a “lock” mode such that the driver may not interact with user device 210 while the vehicle is in motion.

As further shown in FIG. 4, process 400 may include providing the distraction information (block 450). For example, user device 210 may provide the distraction information. In some implementations, user device 210 may provide the distraction information when user device 210 determines the distraction information (e.g., after user device 210 determines the distraction information). Additionally, or alternatively, user device 210 may provide the distraction information at a later time (e.g., when user device 210 is configured to provide the distraction information at a particular interval of time, such as once a day, once a week, etc.)

In some implementations, user device 210 may provide (e.g., via network 230) the distraction information to driving information device 240, and driving information device 240 may store the distraction information (e.g., when driving information device 240 is configured to store distraction information associated with user device 210 and/or vehicle device 220). In some implementations, driving information device 240 may store the distraction information such that the distraction information may be retrieved at a later time (e.g., when the distraction information is to be used to create a driver behavior prediction model).

In this way, user device 210 and/or vehicle device 220 may collect sensor information, and user device 210 may determine distraction information associated with the driver. The distraction information may be used when creating a driver behavior prediction model and/or generating a driver behavior prediction using the driver behavior prediction model.

Although FIG. 4 shows example blocks of process 400, in some implementations, process 400 may include additional blocks, different blocks, fewer blocks, or differently arranged blocks than those depicted in FIG. 4. Additionally, or alternatively, one or more of the blocks of process 400 may be performed in parallel.

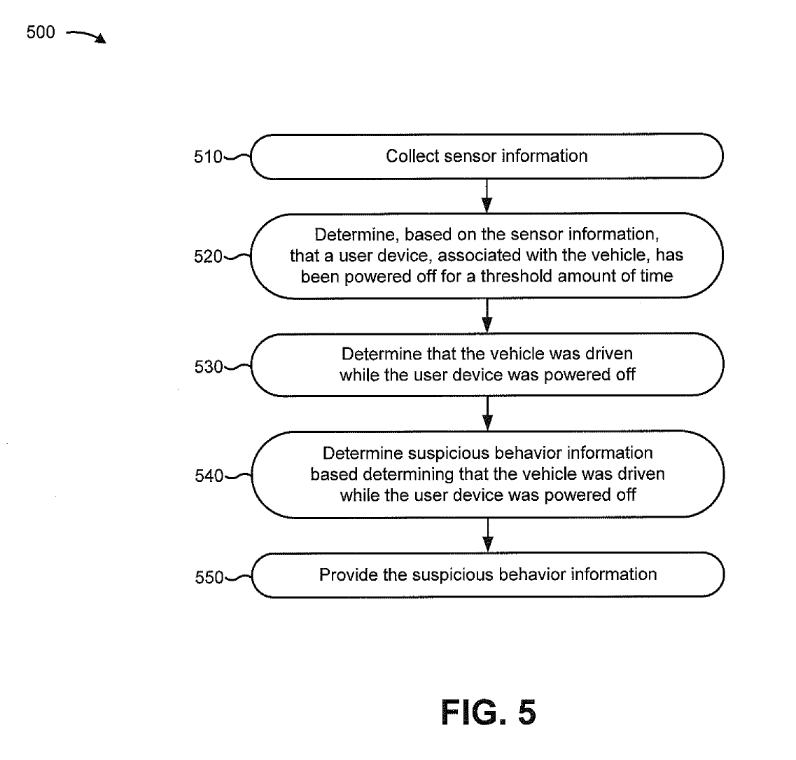

FIG. 5 is a flow chart of an example process 500 for determining suspicious behavior information associated with a driver of a vehicle. In some implementations, process 500 may be implemented using user device 210 and/or vehicle device 220. For example, user device 210 and vehicle device 220 may concurrently (e.g., simultaneously) collect sensor information pertaining to a driver, and user device 210 may determine suspicious behavior information based on sensor information collected by user device 210 and sensor information collected by vehicle device 220 (e.g., when the sensor information collected by vehicle device 220 is provided to user device 210). The blocks of process 500 are primarily discussed herein as being performed by user device 210. However, in some implementations, process 500 may be performed by user device 210 and/or vehicle device 220.

As shown in FIG. 5, process 500 may include collecting sensor information (block 510). For example, user device 210 may collect sensor information. As an additional example, vehicle device 220 may collect sensor information. In some implementations, user device 210 and/or vehicle device 220 may collect the sensor information via on one or more sensors included in user device 210 and/or vehicle device 220.

In some implementations, sensor information may include information collected by a sensor that may be used to determine suspicious behavior information associated with a driver of a vehicle. For example, sensor information may include acceleration information, location information, barometric pressure information, gyroscope information, magnetometer information, proximity information, temperature information, light sensor information, altitude information, audio information, biomarker information, or another type of sensor information. In some implementations, one or more components of user device 210 and/or vehicle device 220 may collect and process the sensor information. In some implementations, vehicle device 220 may collect the sensor information, and may provide the sensor information to user device 210 (e.g., when user device 210 is configured to determine suspicious behavior information based on sensor information collected by user device 210 and/or vehicle device 220).

As further shown in FIG. 5, process 500 may include determining, based on the sensor information, that a user device, associated with the vehicle, has been powered off for a threshold amount of time (block 520). For example, user device 210 may determine that user device 210, associated with the vehicle, has been powered off for a threshold amount of time. In some implementations, user device 210 may determine that user device 210 has been powered off for the threshold amount of time when user device 210 is powered on (e.g., when user device 210 attempts to connect to network 230 associated with user device 210, when a sensor included in user device 210 detects that user device 210 has been powered on, etc.).

As further shown in FIG. 5, process 500 may include determining that the vehicle was driven while the user device was powered off (block 530). For example, user device 210 may determine that that the vehicle, associated with user device 210, was driven while user device 210 was powered off. In some implementations, user device 210 may determine that the vehicle was driven based on sensor information collected by user device 210 and/or vehicle device 220. For example, GPS information, collected by user device 210 and/or vehicle device 220, may be used to determine a location of user device 210 and vehicle device 220 before user device 210 was powered off, and a location of user device 210 and vehicle device 220 after user device 210 was powered on (e.g., after user device 210 was powered off for at least the threshold amount of time). In this example, if the GPS information indicates that user device 210 and vehicle device 220 have moved a threshold distance (e.g., one mile, five miles, fifty miles, etc.), and that user device 210 and vehicle device 220 were near a first geographic location before user device 210 was turned off and are near a second geographic location after user device 210 was turned on, then user device 210 may determine that the vehicle was driven while user device 210 was powered off. As an additional example, sensor information, collected by vehicle device 220, may indicate that the vehicle was driven while user device 210 was powered off.

In some implementations, user device 210 may determine that the user, associated with user device 210, was the driver of the vehicle (e.g., rather than a passenger). For example, vehicle device 220 may determine that the user, associated with user device 210, drove the vehicle while user device 210 was powered off based on sensor information (e.g., an audio sensor, a sensor used to determine a number of persons in the vehicle, etc.) collected by vehicle device 220.

As further shown in FIG. 5, process 500 may include determining suspicious behavior information based on determining that the vehicle was driven while the user device was powered off (block 540). For example, user device 210 may determine suspicious behavior information based on determining that the vehicle was driven while user device 210 was powered off. In some implementations, user device 210 may determine the suspicious behavior information when user device 210 determines that the vehicle was driven while user device 210 was powered off (e.g., after user device 210 determines that the vehicle was driven while user device 210 was powered off).

In some implementations, suspicious behavior information may include a type of driving information associated with a vehicle being driven while user device 210, associated with the vehicle, was powered off. In some implementations, the suspicious behavior information may indicate a suspicious activity by the driver, such as turning off user device 210 to avoid user device 210 monitoring a driving behavior. In some implementations, the suspicious behavior information may include a timestamp associated with user device 210 powering off or powering on, a battery life of user device 210, GPS information indicating a location before user device 210 was powered off, GPS information indicating a location after user device 210 is powered on, and/or any other sensor information collected by user device 210 and/or vehicle device 220, such as vehicle speed information, vehicle acceleration information, or another type of information.

In some implementations, if user device 210 determines (e.g., based on GPS coordinates associated with the vehicle) that the vehicle has been driven while user device 210 was powered off, then user device 210 may determine the suspicious behavior information based on the sensor information (e.g., vehicle speed information, vehicle acceleration information, etc.) collected by user device 210 and/or vehicle device 220.

As further shown in FIG. 5, process 500 may include providing the suspicious behavior information (block 550). For example, user device 210 may provide the suspicious behavior information. In some implementations, user device 210 may provide the suspicious behavior information when user device 210 determines the suspicious behavior information (e.g., after user device 210 determines the suspicious behavior information). Additionally, or alternatively, user device 210 may provide the suspicious behavior information at a later time (e.g., when user device 210 is configured to provide the suspicious behavior information at a particular interval of time, such as once a day, once a week, etc.).

In some implementations, user device 210 may provide (e.g., via network 230) the suspicious behavior information to driving information device 240, and driving information device 240 may store the suspicious behavior information (e.g., when driving information device 240 is configured to store suspicious behavior information associated with user device 210 and/or vehicle device 220). In some implementations, driving information device 240 may store the suspicious behavior information such that the suspicious behavior information may be retrieved at a later time (e.g., when the suspicious behavior information is to be used to create a driver behavior prediction model).

In this way, user device 210 and/or vehicle device 220 may collect sensor information, and user device 210 may determine suspicious behavior information associated with the driver. The suspicious behavior information may be used when creating a driver behavior prediction model and/or generating a driver behavior prediction using the driver behavior prediction model.

Although FIG. 5 shows example blocks of process 500, in some implementations, process 500 may include additional blocks, different blocks, fewer blocks, or differently arranged blocks than those depicted in FIG. 5. Additionally, or alternatively, one or more of the blocks of process 500 may be performed in parallel.

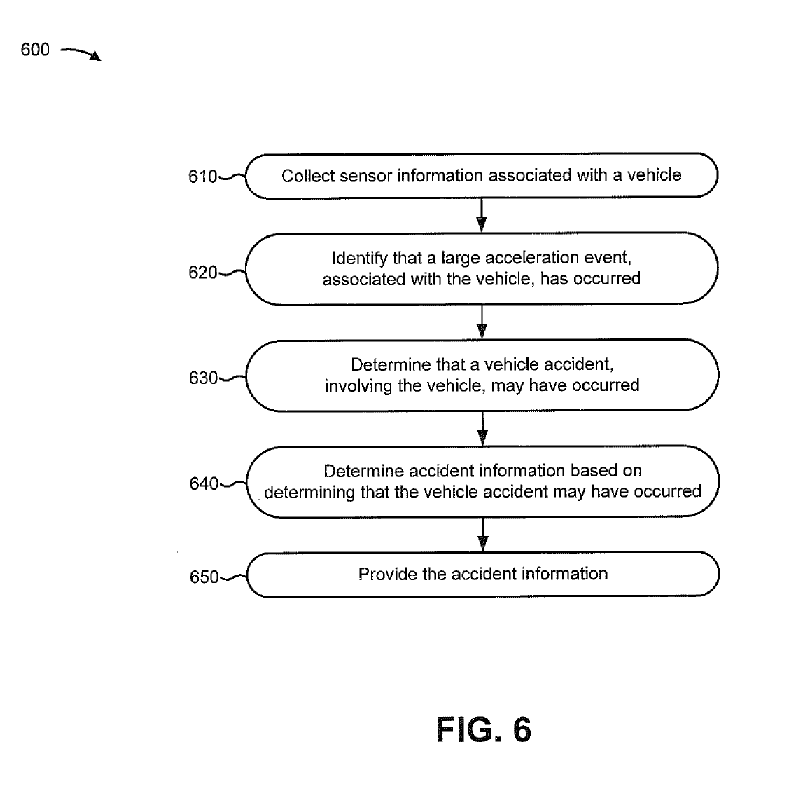

FIG. 6 is a flow chart of an example process 600 for determining accident information associated with a driver. In some implementations, process 600 may be implemented using user device 210 and/or vehicle device 220. For example, user device 210 and vehicle device 220 may concurrently (e.g., simultaneously) collect sensor information pertaining to a driver, and user device 210 may determine accident information based on sensor information collected by user device 210 and sensor information collected by vehicle device 220 (e.g., when the sensor information collected by vehicle device 220 is provided to user device 210). The blocks of process 600 are primarily discussed herein as being performed by user device 210. However, in some implementations, one or more blocks of process 600 may be performed by user device 210 and/or vehicle device 220.

As shown in FIG. 6, process 600 may include collecting sensor information associated with a vehicle (block 610). For example, user device 210 may collect sensor information associated with a vehicle. As an additional example, vehicle device 220 may collect sensor information associated with the vehicle. In some implementations, user device 210 and/or vehicle device 220 may collect the sensor information via on one or more sensors included in user device 210 and/or vehicle device 220.

In some implementations, sensor information may include information collected by a sensor that may be used to determine accident information associated with a driver of a vehicle. For example, sensor information may include acceleration information, location information, barometric pressure information, gyroscope information, magnetometer information, proximity information, temperature information, light sensor information, altitude information, audio information, biomarker information, or another type of sensor information. In some implementations, one or more components of user device 210 and/or vehicle device 220 may collect and process the sensor information. In some implementations, vehicle device 220 may collect the sensor information, and may provide the sensor information to user device 210 (e.g., when user device 210 is configured to determine accident information based on sensor information collected by user device 210 and/or vehicle device 220).

As further shown in FIG. 6, process 600 may include identifying that a major acceleration event, associated with the vehicle, has occurred (block 620). For example, user device 210 may identify that a major acceleration event, associated with the vehicle, has occurred. In some implementations, user device 210 may determine that a major acceleration event has occurred after user device 210 and/or vehicle device 220 collect the sensor information.

A major acceleration event may correspond to acceleration event information associated with a vehicle maneuver (e.g., starting, stopping, turning, etc.) detected by user device 210 and/or vehicle device 220, that indicates that the vehicle has experienced an abnormal acceleration (e.g., an acceleration that is larger than experienced during the normal course of driving). In some implementations, the acceleration event information may include a timestamp of the acceleration event, an event type (e.g., a stop, a start, a turn), a vehicle speed, roadway information (e.g., a hill angle, a slope, etc.). In some implementations, user device 210 may determine that a major acceleration event has occurred based on an acceleration event satisfying a threshold. For example, sensor information collected by user device 210 and/or vehicle device 220 may be stored in a first-in first-out (FIFO) buffer, and the contents of the FIFO buffer may be monitored to determine if a threshold amount of acceleration samples (e.g., based on the sensor information) satisfy a threshold acceleration amount. In this example, if the threshold amount of acceleration samples satisfies the acceleration threshold, then user device 210 may identify that a major acceleration event has occurred.

As further shown in FIG. 6, process 600 may include determining that a vehicle accident, involving the vehicle, may have occurred (block 630). For example, user device 210 may determine that a vehicle accident, involving the vehicle, may have occurred. In some implementations, user device 210 may determine that the vehicle accident may have occurred when user device 210 identifies a large acceleration event has occurred (e.g., after user device 210 identifies the large acceleration event).

In some implementations, user device 210 may determine that the vehicle accident may have occurred based on the sensor information. For example, GPS coordinates of the vehicle may be monitored and used to estimate a vehicle speed. If the major acceleration event occurs while the vehicle speed estimate changes from a positive value to a value close to zero, user device 210 may determine that a vehicle accident may have occurred. Additionally, or alternatively, user device 210 may use other sensors to determine whether a vehicle accident has occurred, such as an audio sensor used to detect vehicle accident indicative sounds (e.g., screeching tires, loud noises, breaking glass, etc.), an airbag sensor (e.g., to detect an airbag deployment, etc.), or another type of sensor.

As further shown in FIG. 6, process 600 may include determining accident information based on determining that the vehicle accident may have occurred (block 640). For example, user device 210 may determine accident information based on determining that the vehicle accident may have occurred. In some implementations, user device 210 may determine the accident information when user device 210 determines that the vehicle accident may have occurred (e.g., after user device 210 determines that the vehicle accident may have occurred).

In some implementations, the accident information may include a type of driving information associated with the possible accident, associated with a driver, detected by user device 210 and/or vehicle device 220. For example, the accident information may include acceleration event information, a timestamp associated with the vehicle accident, a location associated with the vehicle accident, a vehicle speed associated with the vehicle accident, and/or other information associated with determining that the vehicle accident may have occurred.

As further shown in FIG. 6, process 600 may include providing the accident information (block 650). For example, user device 210 may provide the accident information. In some implementations, user device 210 may provide the accident information when user device 210 determines the accident information (e.g., after user device 210 determines the accident information). Additionally, or alternatively, user device 210 may provide the accident information at a later time (e.g., when user device 210 is configured to provide the accident information at a particular interval of time, such as once a day, once a week, etc.).

In some implementations, user device 210 may provide (e.g., via network 230) the accident information to driving information device 240, and driving information device 240 may store the accident information (e.g., when driving information device 240 is configured to store accident information associated with user device 210 and/or vehicle device 220). In some implementations, driving information device 240 may store the accident information such that the accident information may be retrieved at a later time (e.g., when the accident information is to be used to create a driver behavior prediction model).

In some implementations, user device 210 may provide the accident information to an automated emergency response system, such that emergency services may be dispatched to the location of the vehicle accident. Additionally, or alternatively, user device 210 may automatically connect the driver to an emergency call service based on determining the accident information.

In this way, user device 210 and/or vehicle device 220 may collect sensor information, and user device 210 may determine accident information associated with the driver. The accident information may be used when creating a driver behavior prediction model and/or generating a driver behavior prediction using the driver behavior prediction model.

Although FIG. 6 shows example blocks of process 600, in some implementations, process 600 may include additional blocks, different blocks, fewer blocks, or differently arranged blocks than those depicted in FIG. 6. Additionally, or alternatively, one or more of the blocks of process 600 may be performed in parallel.

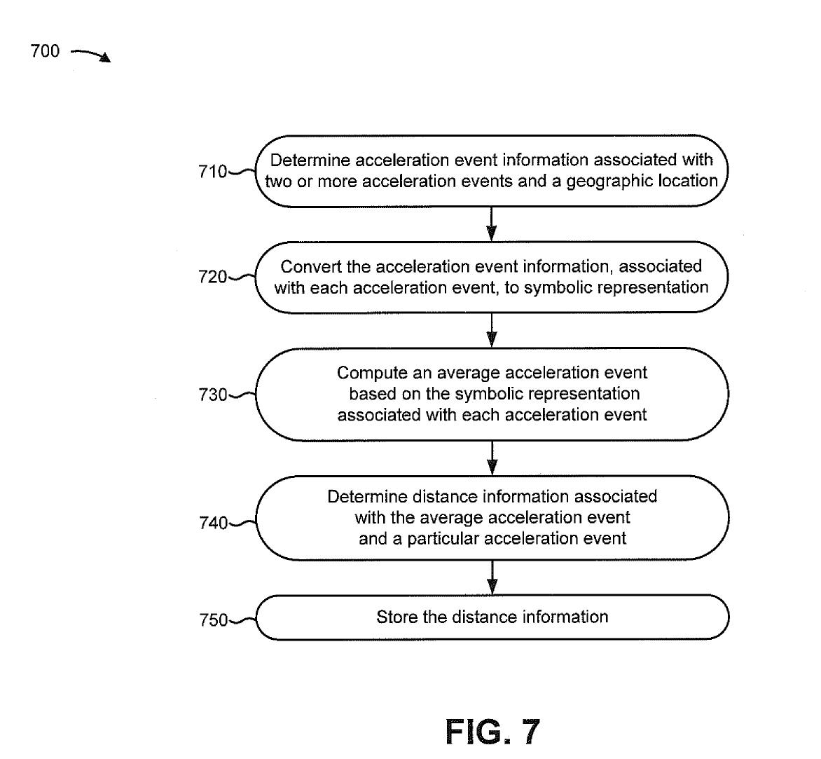

FIG. 7 is a flow chart of an example process 700 for determining distance information associated with an average acceleration event (e.g., associated with a group of drivers), and a particular acceleration event (e.g., associated with a particular driver). In some implementations, one or more process blocks of FIG. 7 may be performed by driving information device 240. In some implementations, one or more process blocks of FIG. 7 may be performed by another device or a group of devices separate from or including driving information device 240, such as modeling device 260.

As shown in FIG. 7, process 700 may include determining acceleration event information associated with two or more acceleration events and a geographic location (block 710). For example, driving information device 240 may determine acceleration event information associated with two or more acceleration events and a geographic location. In some implementations, driving information device 240 may determine the acceleration event information when driving information device 240 receives information indicating that driving information device 240 is to determine average acceleration event information based on the acceleration event information (e.g., when driving information device 240 is configured to determine the acceleration event information at a particular interval of time, when driving information device 240 receives instructions from a user associated with driving information device 240, etc.).

In some implementations, the acceleration event information may include information associated with a vehicle maneuver (e.g., a stop, a start, a turn, etc.) at a particular location. For example, the acceleration event information may include information associated with a negative acceleration event (e.g., a stop), associated with a vehicle at a particular location on a roadway (e.g., an intersection). In some implementations, driving information device 240 may determine acceleration event information associated with a particular location. For example, driving information device 240 may determine acceleration event information for a group of drivers at a particular location.

In some implementations, driving information device 240 may determine the acceleration event information based on information stored by driving information device 240. For example, user device 210 and/or vehicle device 220, each associated with a vehicle, may determine the acceleration event information (e.g., based on sensor information collected by one or more sensors), and may provide the acceleration event information to driving information device 240 for storage. In this example, driving information device 240 may determine the acceleration event information based on the acceleration event information stored by driving information device 240.

As further shown in FIG. 7, process 700 may include converting the acceleration event information, associated with each acceleration event, to a symbolic representation (block 720). For example, driving information device 240 may convert the acceleration event information, associated with each acceleration event, to a symbolic representation. In some implementations, driving information device 240 may convert the acceleration event information to a symbolic representation when driving information device 240 determines the acceleration event information (e.g., after driving information device 240 receives information indicating that driving information device 240 is to determine an average acceleration event).

A symbolic representation of an acceleration event may include a representation of acceleration data, associated with an acceleration event, that may allow for simplified comparison, simplified classification, and/or simplified pattern matching between two or more acceleration events. FIG. 7 is discussed primarily in the context of a symbolic representation. However, the processes and or methods described with regard to FIG. 7 may also be applied to another type of representation that may be used to compare, classify, and/or recognize a pattern associated with two or more acceleration events, such as a representation based on a feature extracted from acceleration data based on a statistical operation (e.g., a statistical operation can include, but is not limited to, determining a mean, determining a median, determining a mode, determining a minimum value, determining a maximum value, determining a quantity of energy, identifying a change in orientation based on sensing a deviation from gravitational force applied to an accelerometer, performing an integration associated with the acceleration data, determining a derivative associated with the acceleration data, etc.) and a binary regression tree, a neural network, a regression classification, a support vector machine algorithm, or the like.

In some implementations, symbolic representation of an acceleration event may be based on one or more time periods associated with an acceleration event and/or one or more acceleration measurements. For example, a first group of acceleration measurements may correspond to a first time period, and may be converted to a symbolic representation in the form of a first numerical value (e.g., an integer, a real number, etc.) that is an average computed based on a square root of a sum of squares of the first group of acceleration measurements. In this example, a second acceleration value may be determined in a similar fashion (e.g., based on a second group of acceleration measurements that correspond to a second time period). In this way, an acceleration event may be symbolically represented by a string of numerical values (e.g., a string of integers, a string of real numbers), where each value in the string corresponds to one time period associated with an acceleration event. In some implementations, driving information device 240 may convert each acceleration event of the two or more acceleration events to symbolic representation (e.g., such that a group of acceleration events, each associated with a different driver, but associated with the same location, may be determined by driving information device 240).

As further shown in FIG. 7, process 700 may include computing an average symbolic representation based on the symbolic representation associated with each acceleration event (block 730). For example, driving information device 240 may compute an average acceleration event based on the symbolic representation associated with each acceleration event. In some implementations, driving information device 240 may compute the average acceleration event after driving information device 240 converts the acceleration event information, associated with each acceleration event, to a symbolic representation (e.g., after driving information device 240 converts the acceleration event information to symbolic representation).

In some implementations, the average acceleration event may include information that identifies an average acceleration event at a particular location based on two or more acceleration events associated with the particular location. For example, an average acceleration event may be computed as an arithmetic mean of each symbolically represented acceleration event associated with a particular location. In some implementations, the average acceleration event may be computed for a particular geographic location (e.g., a particular roadway intersection, a particular roadway curve, etc.). Additionally, or alternatively, the average acceleration event may be computed based on a particular subset of drivers (e.g., when a subset of safe drivers is used to determine the average safe acceleration at a particular geographic location, etc.).

As further shown in FIG. 7, process 700 may include determining distance information associated with the average acceleration event and a particular acceleration event (block 740). For example, driving information device 240 may determine distance information associated with the average acceleration event and a particular acceleration event. In some implementations, driving information device 240 may determine the distance information when driving information device 240 determines that average acceleration event (e.g., after driving information device 240 determines the average acceleration event). Additionally, or alternatively, driving information device 240 may determine the distance information when driving information device 240 receives information indicating that driving information device 240 is to determine the distance information associated with the particular acceleration event.

In some implementations, the distance information may include a distance between the particular acceleration event and the average acceleration event, such as a Euclidean distance, a squared Euclidean distance, or another type of distance metric. In some implementations, the distance may be interpreted as the deviation of a driving behavior of a particular driver (e.g., associated with the particular acceleration event) at the particular location, from the average driving behavior of all drivers (e.g., associated with the average acceleration event) at the particular location. In some implementations, the distance information may include information that identifies a vehicle associated with the particular acceleration event (e.g., a vehicle identifier, a vehicle device 220 identifier, etc.), information that identifies the particular driver associated with the particular acceleration event (e.g., a driver name, a driver ID number, a user device 210 identifier, etc.), information that identifies the particular location associated with the particular acceleration event (e.g., a GPS location, a street name, etc.), or another type of information associated with the distance information.

In some implementations, the distance information may be used in conjunction with other types of driving information (e.g., acceleration event information, vehicle speed information, etc.), associated with one or more other drivers, to determine driver behavior information associated with the particular driver (e.g., a measurement of driver aggression, a measurement of driver safety, etc.).

As further shown in FIG. 7, process 700 may include storing the distance information (block 750). For example, driving information device 240 may store information associated with the distance. In some implementations, driving information device 240 may store the distance information when driving information device 240 determines the distance information (e.g., after driving information device 240 determines the distance information).

In some implementations, driving information device 240 may store the distance information in a memory location (e.g., a RAM, a hard disk, etc.) of driving information device 240. Additionally, or alternatively, driving information device 240 may store the distance information in a memory location of another device (e.g., modeling device 260). In some implementations, driving information device 240 may store the distance information such that the distance information may be retrieved at a later time (e.g., when the distance information is to be used to create a driver behavior prediction model).

In this way, user device 210 and/or vehicle device 220 may collect sensor information, and driving information device 240 may determine distance information representative of an acceleration event associated with the driver. The distance information may be used when creating a driver behavior prediction model and/or generating a driver behavior prediction using the driver behavior prediction model.

Although FIG. 7 shows example blocks of process 700, in some implementations, process 700 may include additional blocks, different blocks, fewer blocks, or differently arranged blocks than those depicted in FIG. 7. Additionally, or alternatively, one or more of the blocks of process 700 may be performed in parallel.

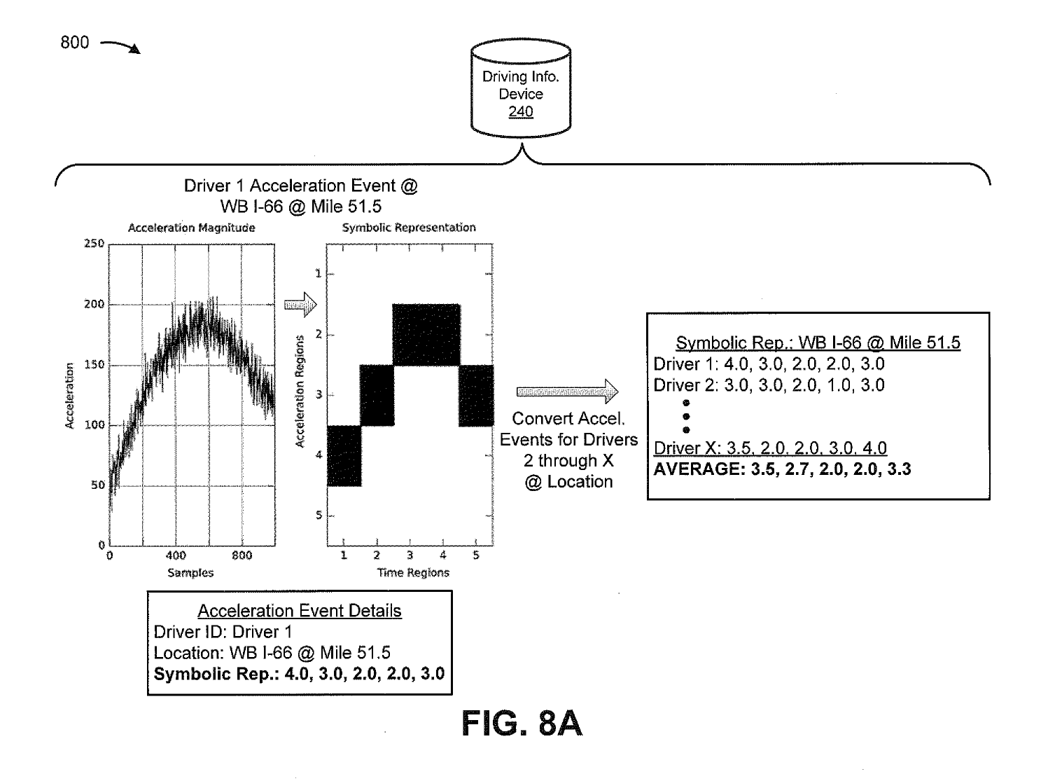

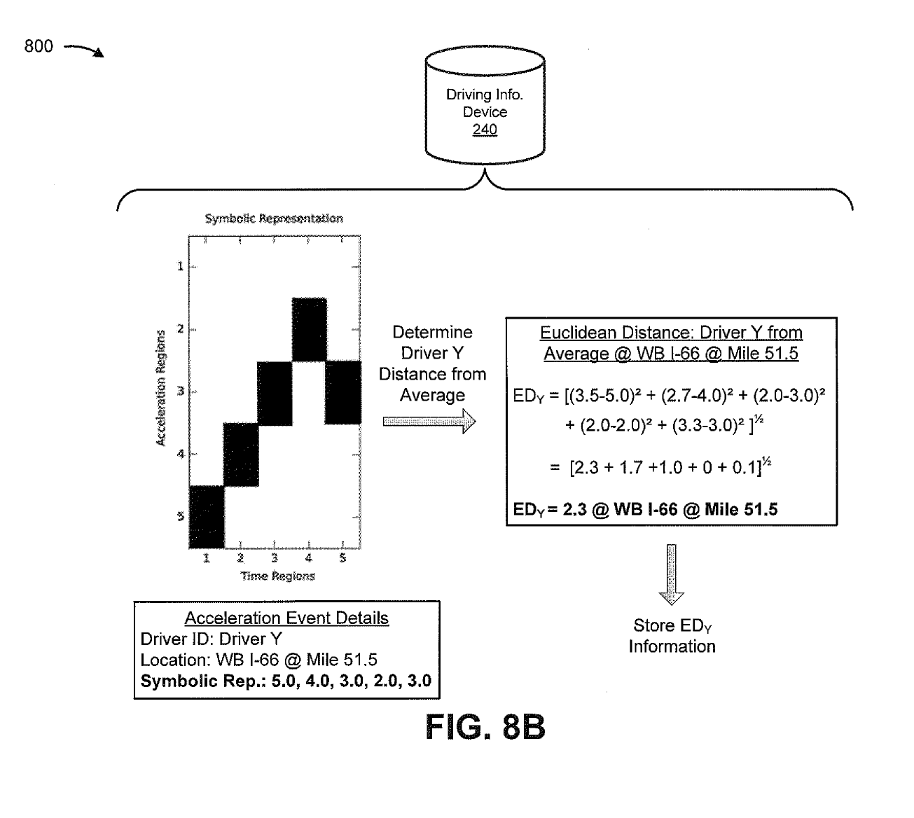

FIGS. 8A and 8B are diagrams of an example implementation 800 relating to example process 700 shown in FIG. 7. For the purposes of example implementation 800, assume that driving information device 240 stores acceleration event information associated with a group of acceleration events at a geographic location (e.g., westbound interstate 66 at mile 51.5), and that each acceleration event is associated with a different driver (e.g., driver 1 through driver X). Further, assume that driving information device 240 has received information indicating that driving information device 240 is to determine distance information indicating a deviation of a particular acceleration event, associated with another driver (e.g., driver Y) and at the geographic location, from an average acceleration event at the geographic location.

As shown in FIG. 8A, driving information device 240 may determine acceleration event information indicating an acceleration event associated with driver 1 at westbound interstate 66 at mile 51.5. As shown, the acceleration event information may be represented as a time series of real valued acceleration magnitude measurements. As shown in the second plot, driving information device 240 may convert the acceleration event information to a symbolic representation by grouping acceleration measurements into a set of time periods (e.g., where a first time period includes acceleration measurements 1 to 200, a second time period includes acceleration measurements 201-400, etc.), and classifying acceleration measurements, included in each time period, as a single value (e.g., using an average acceleration value for acceleration measurements included in each group). As shown, the symbolic representation of the acceleration event associated with driver 1 at westbound interstate 66 at mile 51.5 may be represented graphically and/or may be represented using a string of numerical values (e.g., 4.0, 3.0, 2.0, 2.0, 3.0).

As further shown in FIG. 8A, driving information device 240 may convert acceleration events for driver 2 through driver X at westbound interstate 66 at mile 51.5 in a similar fashion, such that driving information device 240 has converted each acceleration event (e.g., associated with driver 1 through driver X) at the westbound interstate 66 at mile 51.5. As shown, driving information device 240 may then determine an average acceleration event for the geographic location by determining the mean of the symbolically represented acceleration events For example, driving information device 240 may determine the mean of values associated with the first time period of each acceleration event (e.g., 4.0+3.0+ . . . +3.5/X=3.5), the second time period of each acceleration event (e.g., 3.0+3.0+ . . . +2.0/X=2.7), the third time period of each acceleration event (e.g., 2.0+2.0+ . . . +2.0/X=2.0), the fourth time period of each acceleration event (e.g., 2.0+1.0+ . . . +3.0/X=2.0), and the fifth time period of each acceleration event (e.g., 3.0+3.0+ . . . +4.0/X=3.3). For purposes of example implementation 800, assume that the average acceleration event is determined to be 3.5, 2.7, 2.0, 2.0, 3.3.

As shown in FIG. 8B, assume that driving information device 240 determines acceleration event information indicating an acceleration event associated with driver Y at westbound interstate 66 at mile 51.5. As shown, driving information device 240 may convert the acceleration event information to a symbolic representation (e.g., in the manner discussed above). As shown, the symbolic representation of the acceleration event associated with driver Y at westbound interstate 66 at mile 51.5 may be represented graphically and/or may be represented using a string of numerical values (e.g., 5.0, 4.0, 3.0, 2.0, 3.0).

As further shown in FIG. 8B, driving information device 240 may determine distance information, associated with the driver Y acceleration event and the average acceleration event, in the form of a Euclidean distance. As shown, driving information device 240 may determine that the Euclidean distance between the driver Y acceleration event at westbound interstate 66 at mile 51.5 is 2.3 (e.g., ED_{Y}=[(3.5−5.0)²+(2.7−4.0)²+(2.0−3.0)²+(2.0−2.0)²+(3.3−3.0)²]½=[2.3+1.7+1.0+0+0.1]½=2.3). As further shown, driving information device 240 may store the distance information, such as a driver Y identifier, a geographic location identifier, information identifying the Euclidean distance, and/or other information associated with determining the distance information. In some implementations, the distance information associated with driver Y, the symbolically represented acceleration event information associated with driver Y, and other information associated with driver Y may be used to create a driver behavior prediction model and/or generate a driver Y behavior prediction using the driver behavior prediction model.

As indicated above, FIGS. 8A and 8B are provided merely as an example. Other examples are possible and may differ from what was described with regard to FIGS. 8A and 8B.

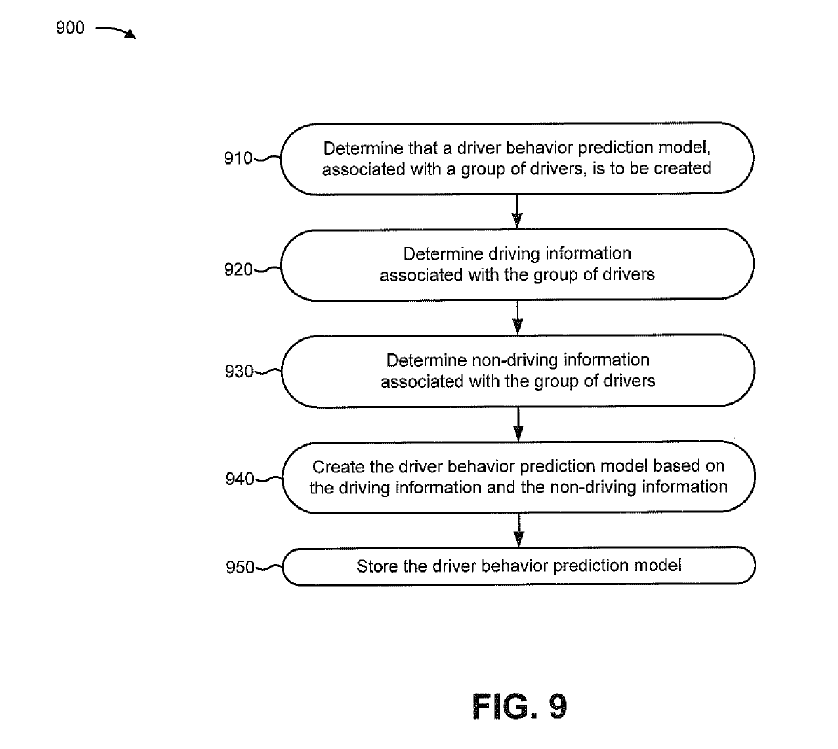

FIG. 9 is a flow chart of an example process 900 for generating a driver prediction model based on driving information, non-driving information, and other information. In some implementations, one or more process blocks of FIG. 9 may be performed by modeling device 260. In some implementations, one or more process blocks of FIG. 9 may be performed by another device or a group of devices separate from or including modeling device 260, such as driving information device 240.

As shown in FIG. 9, process 900 may include determining that a driver behavior prediction model, associated with a group of drivers, is to be created (block 910). For example, modeling device 260 may determine that a driver behavior prediction model, associated with a group of drivers, is to be created. In some implementations, modeling device 260 may determine that the driver behavior prediction model is to be created when modeling device 260 receives information indicating that modeling device 260 is to create the driver behavior prediction model. Additionally, or alternatively, modeling device 260 may determine that the driver behavior prediction model is to be created when modeling device 260 receives input (e.g., from a user of modeling device 260) indicating that modeling device 260 is to create the driver behavior prediction model.

A driver behavior prediction model may include a model that, when provided input information, generates a driver behavior prediction associated with a driver of a vehicle. For example, a driver behavior prediction model may be used to predict the likelihood of driver being involved in a vehicle accident based on information associated with the driver. As an additional example, a driver behavior prediction model may be used to generate and/or bias a driver score (e.g., a numerical value used to predict a safety rating of the driver) based on information associated with the driver.

In some implementations, a user of modeling device 260 may provide input indicating parameters associated with creating the driver behavior prediction model. For example, the user may provide input indicating a type of model to create, a type of driver prediction that the model is to generate (e.g., a score value, a prediction percentage, etc.), a type of information input that is to be used by the model (e.g., a particular type of driving information, a particular type of non-driving information, etc.) and/or other information associated with creating the model. In this way, the user may choose the manner in which to design the driver behavior prediction model for a desired driver prediction.

Additionally, or alternatively, the driver behavior prediction model may be created based on driving information associated with a group of drivers and/or non-driving information associated with the group of drivers, as discussed below.

In some implementations, the driver behavior prediction model may be associated with predicting a driver behavior at a particular geographic location. For example, the driver behavior prediction model may be created based on driving information, associated with a group of drivers and a particular intersection, and may be used to predict how safely another driver will navigate the particular intersection (e.g., based on driving information at other associated with the other driver).

In some implementations, modeling device 260 may identify the group of drivers based on determining that the driver behavior prediction model is to be created. For example, modeling device 260 may determine that modeling device 260 is to create a driver behavior prediction model using information associated with a category of drivers (e.g., a group of safe drivers), and modeling device 260 may identify the group of drivers based on the category (e.g., when modeling device 260 stores information that identifies the group of safe drivers). As another example, modeling device 260 may determine that modeling device 260 is to create a driver behavior prediction model associated with a particular location, and modeling device 260 may identify the group of drivers by determining whether driving information device 240 stores information associated with each driver at the particular location (e.g., if driving information device 240 stores driving information associated with a driver and the particular location, then driver may be included in the group of drivers).

As further shown in FIG. 9, process 900 may include determining driving information associated with the group of drivers (block 920). For example, modeling device 260 may determine driving information associated with the group of drivers. In some implementations, modeling device 260 may determine the driving information when modeling device 260 determines that the driver behavior prediction model, associated with the group of drivers, is to be created. Additionally, or alternatively, modeling device 260 may determine the driving information when modeling device 260 identifies the group of drivers.

In some implementations, driving information, associated with the group of drivers, may include information associated with a driving behavior of each driver of the group of drivers. For example, driving information may include distraction information, suspicious behavior information, accident information, acceleration event information, vehicle speed information, vehicle heading information, location information, and/or another type of information associated with a driving behavior of each driver of the group of drivers. In some implementations, the driving information may also include sensor information collected by user device 210 and/or vehicle device 220 associated with each driver of the group of drivers.

Additionally, or alternatively, the driving information may include acceleration event information associated with a particular geographic location. For example, modeling device 260 may store acceleration event information associated with the group of drivers and a particular roadway intersection, such as information indicating a magnitude of acceleration, associated with each driver of the group of drivers, based on stopping a vehicle at the particular roadway intersection. In some implementations modeling device 260 may compare the acceleration event information, associated with the group of drivers and the particular geographic location, to acceleration event information associated with a particular driver and the geographic location (e.g., and the comparison may be used to bias, influence, update and/or modify a driver score associated with the particular driver).

In some implementations, modeling device 260 may determine the driving information based on information stored by driving information device 240. For example, modeling device 260 may identify the group of drivers, and modeling device 260 may request, from driving information device 240, driving information associated with the group of drivers. In this example, modeling device 260 may determine the driving information based on a response, provided by driving information device 240, to the request. In some implementations, modeling device 260 may determine the driving information based on information associated with the driver behavior prediction model to be created, such as a particular type of driving information that is to be used to create the model.

As further shown in FIG. 9, process 900 may include determining non-driving information associated with the group of drivers (block 930). For example, modeling device 260 may determine non-driving information associated with the group of drivers. In some implementations, modeling device 260 may determine the non-driving information when modeling device 260 determines that the driver behavior prediction model, associated with the group of drivers, is to be created. Additionally, or alternatively, modeling device 260 may determine the non-driving information when modeling device 260 identifies the group of drivers.

In some implementations, non-driving information may include information, associated with the group of drivers, that is not directly related to a driving behavior.

For example, non-driving information may include an age of each driver, a gender of each driver, a home address of each driver, an income level of each driver, an accident history of each driver, a marital status of each driver, health information associated with each driver, biometric authentication information associated with each driver, a number of years that each driver has been driving, a spending history of each driver, social networking information associated with each driver (e.g., a quantity of social networking posts made over a period of time, etc.), telephone usage information associated with each driver, text messaging activity associated with each driver (e.g., a quantity of text messages sent over a period of time, a quantity of text messages sent while at a particular geographic location, etc.) driver archetype information, or another type of non-driving information.

Additionally, or alternatively, non-driving information may include another type of information that may be useful to create a driver behavior prediction model. For example, non-driving information may include a driver prediction associated with each driver of the group of drivers (e.g., an existing prediction associated with each driver, such as an insurance cost prediction, an accident likelihood prediction, etc.). As an additional example, non-driving information may include information relevant to the particular driver behavior prediction model, such as elevation information, weather information (e.g., a weather forecast, a temperature, a quantity of light, etc.), traffic information (e.g., an amount of traffic density, information associated with a traffic pattern, etc.), information associated with a time of day (e.g., a sunrise time, a sunset time, a time that a particular driver was a at a geographic location, etc.) or any other type of information that may be useful when creating the driver behavior prediction model.

In some implementations, modeling device 260 may determine the non-driving information based on information stored by non-driving information device 250. For example, modeling device 260 may identify the group of drivers, and modeling device 260 may request, from non-driving information device 250, non-driving information associated with the group of drivers. In this example, modeling device 260 may determine the non-driving information based on a response, provided by non-driving information device 250, to the request. In some implementations, modeling device 260 may determine the non-driving information based on information associated with the driver behavior prediction model to be created, such as a particular type of non-driving information that is to be used to create the model.

As further shown in FIG. 9, process 900 may include creating the driver prediction model based on the driving information and the non-driving information (block 940). For example, modeling device 260 may create the driver prediction model based on the driving information and the non-driving information determined by modeling device 260. In some implementations, modeling device 260 may create the driver behavior prediction model when modeling device 260 determines the driving information and the non-driving information (e.g., after modeling device 260 determines each type of information).

In some implementations, the driver behavior prediction model may be created based on the driving information (e.g., determined by user device 210 and/or vehicle device 220) and the non-driving information. Additionally, or alternatively, modeling device 260 may create the driving behavior prediction model in the form of a particular learning model type, such as a classification tree, a univariate linear regression model, a multivariate linear regression model, an artificial neural network, a Gaussian Process model, a Bayesian Inference model, a support vector machine, or another type of modeling technique, and the driver behavior prediction model may learn (e.g., may be automatically updated) based on updated and/or additional information (e.g., driving information, non-driving information, etc.) received by modeling device 260 at a later time (e.g., after the driver behavior prediction model is initially created). In some implementations, modeling device 260 may automatically update the drive behavior prediction model. Additionally, or alternatively, modeling device 260 may update the driver behavior prediction model when a user, associated with modeling device 260, indicates that the model is to be updated. Additionally, or alternatively, modeling device 260 may perform cross-validation using the driver behavior prediction model to estimate model accuracy.

In some implementations, the driver behavior prediction model may be designed such that the driving behavior prediction model may generate a driver prediction associated with an unknown driver (e.g., a driver that is not necessarily included in the group of drivers whose information was used to create the driver behavior prediction model). For example, first information (e.g., driving information, non-driving information, etc.) associated with a first known subset of drivers (e.g., a subset of good drivers, a subset of safe drivers, etc.), and second information (e.g., driving information, non-driving information, etc.) associated with a second known subset of drivers (e.g., a subset of bad drivers, a subset of unsafe drivers, etc.) may be used to generate the driver behavior prediction model (e.g., the driver behavior prediction model may be trained using the first information and the second information). In this example, third information (e.g., driving information, non-driving information, etc.) associated with an unknown driver (e.g., a driver not included in the first subset of drivers or the second subset of drivers) may be provided to the driver behavior prediction model, and the driver behavior prediction model may generate a driver prediction based on the third information. In other words, the driver behavior prediction model may be used to classify the unknown driver as being included in a particular subset of drivers (e.g., the unknown driver may be classified as a good driver, as a bad driver, as a safe driver, as an unsafe driver, etc.)

Additionally, or alternatively, the driver behavior prediction model may be designed such that information associated with another driver (e.g., driving information, non-driving information, etc.) may be provided as an input to the driver behavior prediction model to generate a driver prediction for the other driver. In this way, a driver behavior, associated with the other driver, may be predicted by the driver behavior prediction model based on information associated with the other driver.

As further shown in FIG. 9, process 900 may include storing the driver behavior prediction model (block 950). For example, modeling device 260 may store the driver behavior prediction model. In some implementations, modeling device 260 may store the driver behavior prediction model when modeling device 260 creates the driver behavior prediction model (e.g., after modeling device 260 creates the driver behavior prediction model).

In some implementations, modeling device 260 may store the driver behavior prediction model in a memory location (e.g., a RAM, a hard disk, etc.) of modeling device 260. Additionally, or alternatively, modeling device 260 may provide the driver behavior prediction model for storage in another storage location (e.g., included in another device). In some implementations, modeling device 260 may store the driver behavior prediction model such that the driver behavior prediction model may be retrieved at a later time (e.g., when the driver behavior prediction model is to be used to generate a driver prediction).

In this way, modeling device 260 may create a driver behavior prediction model based on information (e.g., driving information, non-driving information, etc.) gathered from multiple sources (e.g., user device 210, vehicle device 220, one or more sensors, one or more databases, etc.). Furthermore, the driver behavior prediction model may be created using detailed information to generate specific driver predictions, such as a driver prediction associated with a particular intersection at a particular time of day.

Although FIG. 9 shows example blocks of process 900, in some implementations, process 900 may include additional blocks, different blocks, fewer blocks, or differently arranged blocks than those depicted in FIG. 9. Additionally, or alternatively, one or more of the blocks of process 900 may be performed in parallel.

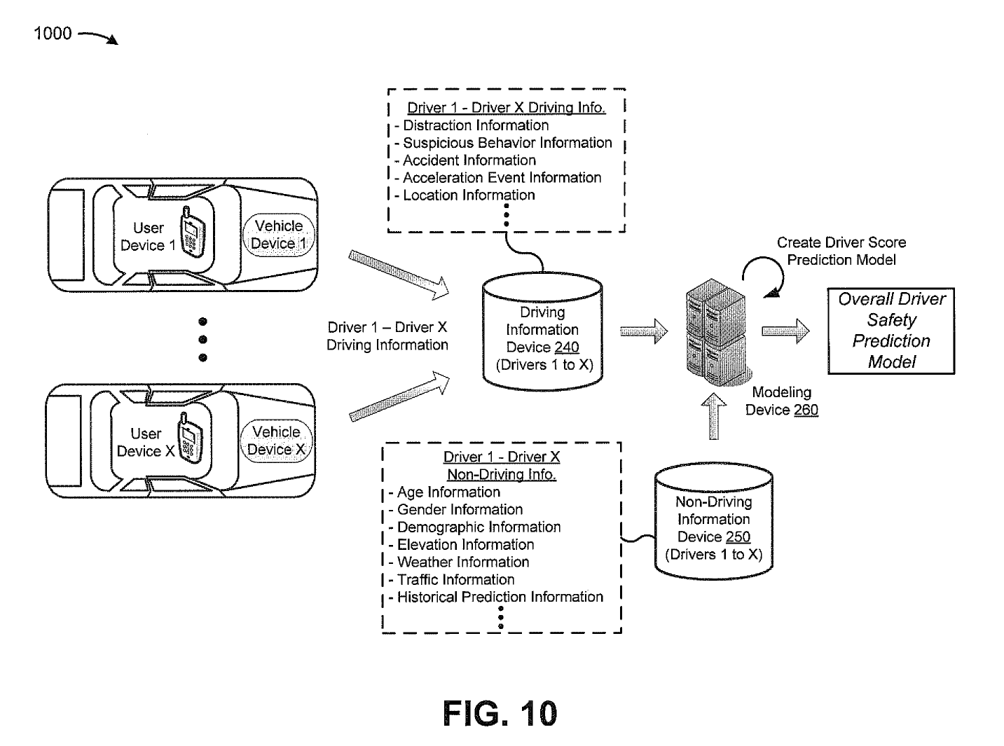

FIG. 10 is a diagram of an example implementation 1000 relating to example process 900 shown in FIG. 9. For the purposes of example implementation 1000, assume that each user device of a group of user devices (e.g., user device 1 through user device X) and each vehicle device of a group of vehicle devices (e.g., vehicle device 1 through vehicle device X) are associated with a respective vehicle (e.g., vehicle 1 through vehicle X), and a respective driver (e.g., driver 1 through driver X). Further, assume that all user devices and vehicle devices are configured to collect sensor information and determine driving information (e.g., associated with their respective drivers) based on the sensor information. Finally, assume that a non-driving information device 250 stores non-driving information associated with driver 1 through driver X.

As shown in FIG. 10, assume that user device 1 through user device X and vehicle device 1 through vehicle device X determine (e.g., using one or more sensors, etc.) various types of driving information associated with driver 1 through driver X. As shown, user device 1 through user device X and vehicle device 1 through vehicle device X may provide the driving information to driving information device 240. As shown, the driving information may include distraction information, suspicious behavior information, accident information, acceleration event information, location information, and/or other driving information associated with each driver.

As further shown, assume that modeling device 260 determines (e.g., based on input provided by a user associated with modeling device 260) that modeling device 260 is to create a driver behavior prediction model (e.g., an overall driver safety prediction model) based on driving information associated with driver 1 through driver X. As further shown, modeling device 260 may determine (e.g., based on information stored by driving information device 240) driving information associated with driver 1 through driver X. As shown, the driving information may include distraction information, suspicious behavior information, accident information, acceleration event information, location information, and/or other driving information.

As further shown, modeling device 260 may determine (e.g., based on information stored by non-driving information device 250) non-driving information associated with driver 1 through driver X. As shown, the non-driving information may include driver age information, driver gender information, driver demographic information, elevation information, driver social networking information, telephone usage information, driver spending information, driver archetype information, weather information, traffic information, historical driver prediction information, and/or other non-driving information.

As further shown in FIG. 10, modeling device may create the driver behavior prediction model (e.g., the overall driver safety prediction model) based on the driving information and the non-driving information associated with driver 1 through driver X (e.g., and based on model parameters selected by the user). As further shown, modeling device 260 may store the overall driver safety prediction model for future use.

As indicated above, FIG. 10 is provided merely as an example. Other examples are possible and may differ from what was described with regard to FIG. 10.

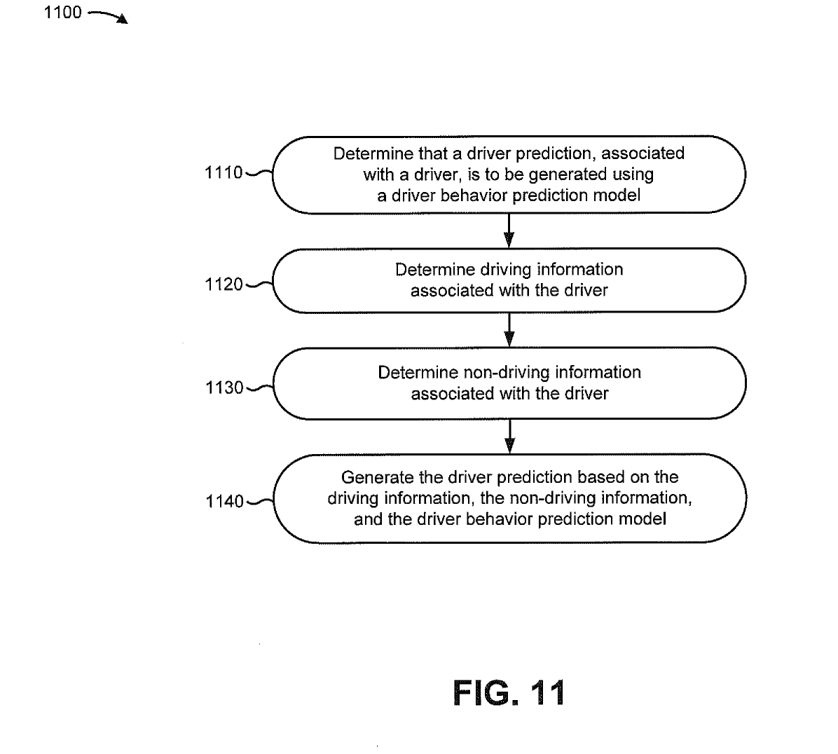

FIG. 11 is a flow chart of an example process 1100 generating a driver prediction based on a driver behavior prediction model. In some implementations, one or more process blocks of FIG. 11 may be performed by modeling device 260. In some implementations, one or more process blocks of FIG. 11 may be performed by another device or a group of devices separate from or including modeling device 260, such as driving information device 240.

As shown in FIG. 11, process 1100 may include determining that a driver prediction, associated with a driver, is to be generated using a driver behavior prediction model (block 1110). For example, modeling device 260 may determine that a driver prediction, associated with a driver, is to be generated using a driver behavior prediction model. In some implementations, modeling device 260 may determine that the driver prediction is to be generated when modeling device 260 receives, from a user associated with modeling device 260, input indicating that modeling device 260 is to generate the driver prediction associated with the driver. Additionally, or alternatively, modeling device 260 may determine that the driver prediction is to be generated when modeling device 260 receives information indicating that the driver prediction, associated with the driver, is to be generated (e.g., from another device, such as driving information device 240).

In some implementations, modeling device 260 may receive information associated with the driver that is to be the subject of the driver prediction. For example, modeling device 260 may receive (e.g., via user input) a driver identifier (e.g., a driver name, a driver identification number, etc.) associated with the driver. In this example, modeling device 260 may determine stored information (e.g., driving information, non-driving information, etc.) based on the driver identifier (e.g., modeling device 260 may retrieve the stored information from a storage location), as discussed below.

Additionally, or alternatively, modeling device 260 may determine information associated with a driver behavior prediction model that is to be used to generate the driver prediction. For example, modeling device 260 may receive (e.g., via user input) information that identifies the driver behavior prediction model (e.g., a model name, a model identifier, etc.). In this example, modeling device 260 may retrieve (e.g., from storage) the driver behavior prediction model based on the information that identifies the driver behavior prediction model.

In some implementations, modeling device 260 may determine a type of information that is required to generate the driver prediction. For example, modeling device 260 may determine the driver behavior prediction model, and may determine a type of information required to generate the driver prediction (e.g., modeling device 260 may determine what input information is required by the model to generate the driver prediction). In this example, modeling device 260 may determine stored information (e.g., driving information, non-driving information, etc.) based on determining the type of information required to generate the driver prediction.

As further shown in FIG. 11, process 1100 may include determining driving information associated with the driver (block 1120). For example, modeling device 260 may determine driving information associated with the driver. In some implementations, modeling device 260 may determine the driving information when modeling device 260 determines that the driver prediction, associated with the driver, is to be generated. Additionally, or alternatively, modeling device 260 may determine the driving information when modeling device 260 identifies the driver (e.g., based on user input, etc.). Additionally, or alternatively, modeling device 260 may determine the driving information when modeling device 260 determines the driver behavior prediction model (e.g., when modeling device 260 determines the driving information that is required to generate the driver prediction).

As discussed above, driving information may include distraction information, suspicious behavior information, accident information, acceleration event information, vehicle speed information, location information, and/or another type of information associated with a driving behavior of the driver. In some implementations, the driving information may also include sensor information collected by user device 210 and/or vehicle device 220 associated with the driver.

In some implementations, modeling device 260 may determine the driving information based on information stored by driving information device 240. For example, modeling device 260 may identify the driver, and modeling device 260 may request, from driving information device 240, driving information associated with the driver. In this example, modeling device 260 may determine the driving information based on a response, provided by driving information device 240, to the request.

As further shown in FIG. 11, process 1100 may include determining non-driving information associated with the driver (block 1130). For example, modeling device 260 may determine non-driving information associated with the driver. In some implementations, modeling device 260 may determine the non-driving information when modeling device 260 determines that the driver prediction, associated with the driver, is to be generated. Additionally, or alternatively, modeling device 260 may determine the non-driving information when modeling device 260 identifies the driver. Additionally, or alternatively, modeling device 260 may determine the non-driving information when modeling device 260 determines the driver behavior prediction model (e.g., when modeling device 260 determines the non-driving information that is required to generate the driver prediction).

As discussed above, the non-driving information may include information, associated with the driver, that is not directly related to a driving behavior, such as a driver age, a driver gender, a home address, an income, elevation information, weather information, traffic information, or another type of non-driving information.

In some implementations, modeling device 260 may determine the non-driving information based on information stored by non-driving information device 250. For example, modeling device 260 may identify the driver, and modeling device 260 may request, from non-driving information device 250, non-driving information associated with the driver. In this example, modeling device 260 may determine the non-driving information based on a response, provided by non-driving information device 250, to the request.

As further shown in FIG. 11, process 1100 may include generating the driver prediction based on the driving information, the non-driving information, and the driver behavior prediction model (block 1140). For example, modeling device 260 may generate the driver prediction based on the driving information, the non-driving information, and the driver behavior prediction model. In some implementations, modeling device 260 may generate the driver prediction when modeling device 260 determines the driving information and the non-driving information (e.g., after modeling device 260 determines each type of information). Additionally, or alternatively, modeling device 260 may generate the driver prediction when modeling device 260 determines the driver behavior prediction model to be used to generate the drive prediction.

In some implementations, the driver prediction may be in the form of a numerical value, such as a driver score. For example, a driver behavior prediction model may be designed to predict a driver score using values between 0 and 100, and the driver prediction may be in the form of a numerical value between 0 and 100. Additionally, or alternatively, the driver prediction may be in the form of a percentage. For example, a driver behavior prediction model may be designed to predict the likelihood of a driver being involved in a vehicle accident at a particular intersection in the next six months, and the driver prediction may be in the form of a percentage (e.g., 3%, 60%, etc.) of likelihood of the driver being involved in an accident. Additionally, or alternatively, the driver prediction may be in the form of a driver score bias. For example, a driver may be associated (e.g., by default) with a driver score (e.g., 50 out of 100), and the driver prediction may be in the form of a driver score bias that decreases or increases the driver safety score (e.g., the driver safety score may be decreased by 5 points based on an “unsafe” driving prediction, the driver safety score may be increased by 8 points based on a “safe” driving prediction, etc.). Additionally, or alternatively, the driver prediction may be in some other form. In some implementations, the form of the driver prediction may be determined based on the driver behavior prediction model (e.g., when the driver behavior prediction model is designed to provide a particular type of driver prediction).

In some implementations, modeling device 260 may generate the driver prediction, and may provide the driver prediction. For example, modeling device 260 may generate the driver prediction, and may provide (e.g., via a display screen associated with modeling device 260) the driver prediction to a user of modeling device 260. In this way, modeling device 260 may generate a driver prediction (e.g., that can be used for UBI insurance purposes) based on a driver behavior prediction model and based on information (e.g., driving information, non-driving information, etc.) gathered from multiple sources (e.g., user device 210, vehicle device 220, one or more sensors, one or more databases, etc.) associated with the driver.

Although FIG. 11 shows example blocks of process 1100, in some implementations, process 1100 may include additional blocks, different blocks, fewer blocks, or differently arranged blocks than those depicted in FIG. 11. Additionally, or alternatively, one or more of the blocks of process 1100 may be performed in parallel.

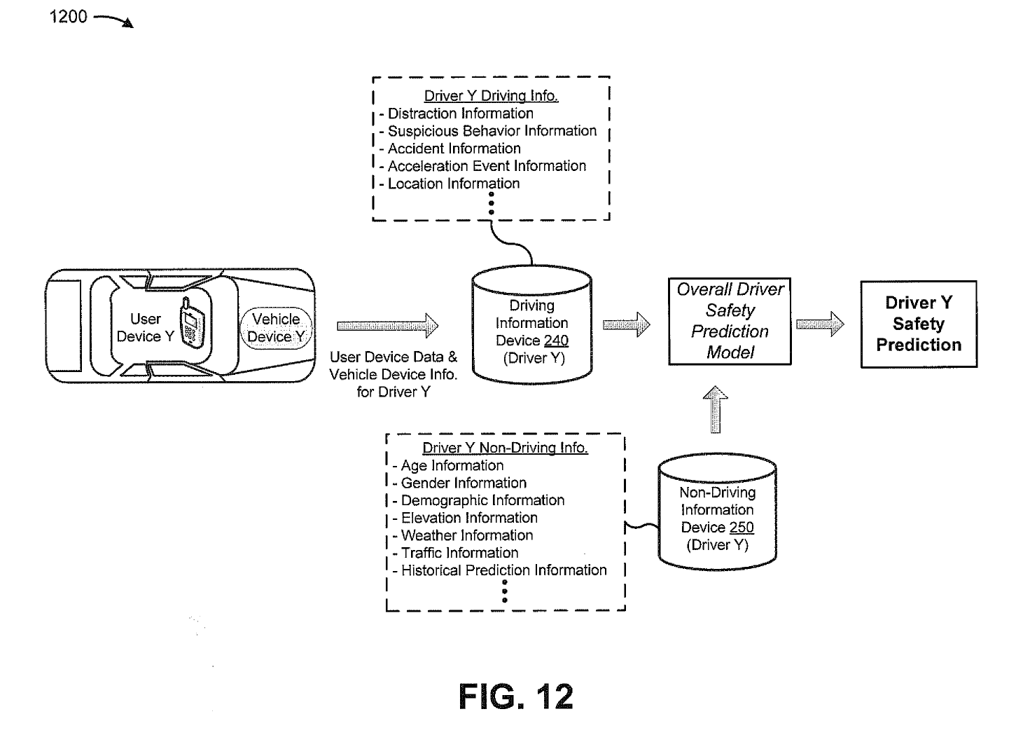

FIG. 12 is a diagram of an example implementation 1200 relating to example process 1100 shown in FIG. 11. For the purposes of example implementation 1200, assume that user device Y and vehicle device Y are associated with vehicle Y and driver Y. Further, assume that device Y and vehicle device Y are configured to collect sensor information and determine driving information, associated with driver Y, based on the sensor information. Also, assume that a non-driving information device 250 stores non-driving information associated with driver Y and other information that may be used to generate a driver prediction. Finally, assume that modeling device 260 has created and stored an overall driver safety prediction model that is designed to predict an overall driver safety score.

As shown in FIG. 12, assume that user device Y and vehicle device Y determine (e.g., using one or more sensors, etc.) various types of driving information associated with driver Y. As shown, user device Y and vehicle device Y may provide the driving information to driving information device 240. As shown, the driving information may include distraction information, suspicious behavior information, accident information, acceleration event information, location information, and other driving information associated with each driver.

As further shown, assume that modeling device 260 determines (e.g., based on input provided by a user associated with modeling device 260) that modeling device 260 is to generate a driver prediction for driver Y based on information associated with driver Y and the overall driver safety prediction model stored by modeling device 260. As further shown, modeling device 260 may determine (e.g., based on information stored by driving information device 240) driving information associated with driver Y to be input into the model. As shown, the driving information may include distraction information, suspicious behavior information, accident information, acceleration event information, location information, and other driving information.

As further shown, modeling device 260 may determine (e.g., based on information stored by non-driving information device 250) non-driving information associated with driver Y to be input into the model. As shown, the non-driving information may include driver Y age information, driver Y gender information, driving Y demographic information, elevation information, weather information, traffic information, historical driver Y prediction information, and other non-driving information.

As further shown in FIG. 12, modeling device may generate the driver Y prediction by inputting the driver Y driving information and the driver Y non-driving information into the overall driver safety prediction model. As shown, modeling device 260 may generate the driver Y prediction based on the model, and modeling device 260 may also provide the driver Y safety prediction to the user (e.g., via a display screen associated with modeling device 260).

As indicated above, FIG. 12 is provided merely as an example. Other examples are possible and may differ from what was described with regard to FIG. 12.

Implementations described herein may create a driver behavior prediction model based on information (e.g., driving information, non-driving information, etc.), gathered from a variety of sources (e.g., sensors, devices, databases, etc.), associated with a group of drivers. In this way, the driver behavior prediction model may be used to predict a future driving behavior associated with a driver.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations shown in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A system, comprising:
one or more devices to:
determine driving information associated with a group of users,
the driving information being based on sensor information collected by at least two of a group of user devices, a first group of vehicle devices used in association with a corresponding group of vehicles associated with the group of users, or a group of second vehicle devices installed in the corresponding group of vehicles;
determine non-driving information associated with the group of users;
create a driver behavior prediction model based on the driving information, and the non-driving information; and
store the driver behavior prediction model,
the driver behavior prediction model permitting a driver prediction to be made regarding a particular user.

2. The system of claim 1, where the driving information includes:
distraction information associated with a user of the group of users,
when determining the distraction information, the one or more devices are to:
collect sensor information associated with a vehicle,
the vehicle being associated with the user;
determine, based on the sensor information, that the vehicle is in motion;
determine that the user, associated with the vehicle, is interacting with a user device while the vehicle is in motion; and
determine the distraction information based on determining that the user is interacting with the user device while the vehicle is in motion.

3. The system of claim 1, where the driving information includes:
suspicious behavior information associated with a user of the group of users,
when determining the suspicious behavior information, the one or more devices are to:
collect sensor information associated with a user device,
the user device being associated with the user;
determine, based on the sensor information, that the user device has been powered off for a threshold amount of time;
determine that a vehicle, associated with the user, has been driven while the user device was powered off; and
determine the suspicious behavior information based on determining that the vehicle was driven while the user device was powered off.

4. The system of claim 1, where the driving information includes:
accident information associated with a user of the group of users,
when determining the accident information, the one or more devices are to:
collect sensor information associated with a vehicle,
the vehicle being associated with the user;
determine, based on the sensor information, information indicating that an acceleration event, associated with the vehicle, has occurred;
determine that a vehicle accident, involving the vehicle, has occurred based on the information indicating that the acceleration event has occurred and the sensor information; and
determine the accident information based on determining that the vehicle accident has occurred.

5. The system of claim 1, where the driving information includes:
distance information associated with a particular acceleration event and a user of the group of users,
when determining the distance information, the one or more devices are to:
determine acceleration event information associated with a group of acceleration events,
the group of acceleration events being associated with the group of users;
determine distance information for the particular acceleration event based on the acceleration event information associated with the group of acceleration events.

6. The system of claim 1, where the one or more devices are further to:
determine that the driver prediction, associated with the particular user, is to be generated using the driver behavior prediction model;
determine driving information associated with the particular user,
the driving information associated with the particular user being based on sensor information collected by a user device associated with the particular user,
the driving information associated with the particular user being based on sensor information collected by a first vehicle device associated with the particular user,
the first vehicle device being connected to a vehicle associated with the particular user, or
the driving information associated with the particular user being based sensor information collected by a second vehicle device associated with the particular user,
the second vehicle device being installed in the vehicle associated with the particular user;
determine non-driving information associated with the particular user;
generate the driver prediction by inputting the driving information associated with the particular user and the non-driving information associated with the particular user into the driver behavior prediction model; and
provide the driver prediction for display.

7. The system of claim 1, where the driver prediction includes at least one of:
a driver score associated with the particular driver;
a percentage of likelihood associated with the particular driver; or
a driver score bias associated with the particular driver.

8. A system, comprising:
one or more devices:
receive sensor information collected by a set of collection devices,
the set of collection devices including one or more user devices and one or more vehicle devices;
determine driving information associated with a set of users,
the set of users corresponding to the set of collection devices,
the driving information being based on the sensor information, and including information that identifies a geographic location associated with the set of users;
determine non-driving information associated with the set of users and the geographic location;
create a driver behavior prediction model based on the driving information and the non-driving information; and
store the driver behavior prediction model,
the driver behavior prediction model permitting a driver prediction to be made regarding a particular user.

9. The system of claim 8, where the set of collection devices include at least one of:
a smart phone;
an onboard diagnostics device associated with a vehicle; or
a telematics device associated with a vehicle.

10. The system of claim 8, where the set of collection devices include:
a telematics device that interfaces with a communication bus of a vehicle.

11. The system of claim 8, where the driving information includes:
accident information associated with a user of the set of users,
when determining the accident information, the one or more devices are to:
collect sensor information associated with a vehicle,
the vehicle being associated with the user;
determine, based on the sensor information, information indicating that an acceleration event, associated with the vehicle, has occurred;
determine that a vehicle accident, involving the vehicle, has occurred based on the information indicating that the acceleration event has occurred and the sensor information; and
determine the accident information based on determining that the vehicle accident has occurred.

12. The system of claim 8, where the driving information includes:
distance information associated with a particular acceleration event and a user of the set of users,
when determining the distance information, the one or more devices are to:
determine acceleration event information associated with a group of acceleration events,
the group of acceleration events being associated with the set of users;
determine distance information for the particular acceleration event based on the acceleration event information associated with the group of acceleration events.

13. The system of claim 8, where the one or more devices are further to:
determine that a driver behavior prediction, associated with a particular user, is to be generated using the driver behavior prediction model;
determine driving information associated with the particular user,
the driving information associated with the particular user being based on sensor information collected by a collection device associated with the particular user;
generate the driver behavior prediction by inputting the driving information associated with the particular user and the non-driving information associated with the particular user into the driver behavior prediction model; and
present, for display, the driver behavior prediction.

14. The system of claim 13, where the driver behavior prediction includes at least one of:
a driver score associated with the particular user;
a percentage of likelihood associated with the particular user; or
a driver score bias associated with the particular user.

15. A method, comprising:
determining, by one or more devices, driving information associated with a plurality of users and a particular geographic location,
the driving information being based on sensor information collected by user devices and/or vehicle devices, associated with the plurality of users, at the particular geographic location;
determining, by the one or more devices, non-driving information associated with the plurality of users and/or the particular geographic location;
creating, by the one or more devices, a driver behavior prediction model based on the driving information and the non-driving information; and
storing, by the one or more devices, the driver behavior prediction model,
the driver behavior prediction model associating driving information, associated with the plurality of users, and non-driving information, associated with the plurality of users, and/or the particular geographic location, and
the driver behavior prediction model allowing a driver prediction, associated with a particular user and the particular geographic location, to be generated.

16. The method of claim 15, further comprising:
determining additional driving information associated with the particular user, and additional non-driving information associated with the particular user; and
biasing the driver prediction, associated with the particular user, based on the driver behavior prediction model, the additional driving information, and the additional non-driving information.

17. The method of claim 15, further comprising:
determining first acceleration event information associated with the particular user and the particular geographic location,
the first acceleration event information being of an event type associated with a vehicle stop at the particular geographic location, an event type associated with a vehicle start event at the particular geographic location, or an event type associated with a vehicle turn event at the particular geographic location;
determining second acceleration event information associated with the plurality of users and the particular geographic location,
the second acceleration event being of a same event type as the event type of the first acceleration event;
comparing the first acceleration event information and the second acceleration event information; and
biasing the driver prediction, associated with the particular user, based on the comparing the first acceleration event information and the second acceleration event information.

18. The method of claim 15, where the non-driving information includes at least one of:
driver demographic information;
a driver age;
information associated with a marital status;
driver health information;
biometric authentication information;
a time of day;
information associated with a quantity of light;
information associated with social networking activity;
information associated with phone usage;
information associated with text messaging;
traffic information; or
weather information.

19. The method of claim 15, where the driving information includes:
distraction information associated with the particular geographic location and a user of the plurality of users:
the distraction information being determined by:
collecting sensor information associated with a vehicle,
the vehicle being associated with the user;
determining, based on the sensor information, that the vehicle is in motion;
determining that the user, associated with the vehicle, is interacting with a user device while the vehicle is in motion; and
determining the distraction information based on determining that the user is interacting with the user device while the vehicle is in motion.

20. The method of claim 15, further comprising:
determining that the driver prediction, associated with the particular user, is to be generated using the driver behavior prediction model;
determining driving information associated with the particular user and the particular geographic location,
the driving information being based on sensor information collected by a user device and/or a vehicle device associated with the particular user;
determining non-driving information associated with the particular user and the particular geographic location;
generating the driver prediction by inputting the driving information, associated with the particular user and the particular geographic location, and the non-driving information, associated with the particular user and/or the particular geographic location, into the driver behavior prediction model; and
providing, for display, the driver prediction.
